(19) United States
(12) Patent Application Publication
(10) Pub. No.: US 2014/0046690 A1
(43) Pub. Date: Feb. 13, 2014

(54) MANAGEMENT AND DISTRIBUTION OF PATIENT INFORMATION

(71) Applicants: Bruce D. Gunderson, Plymouth, MN (US); Kevin T. Ousdigian, Shoreview, MN (US); Amisha S. Patel, Apex, NC (US)

(72) Inventors: Bruce D. Gunderson, Plymouth, MN (US); Kevin T. Ousdigian, Shoreview, MN (US); Amisha S. Patel, Apex, NC (US)

(73) Assignee: Medtronic, Inc., Minneapolis, MN (US)

(21) Appl. No.: 13/570,884

(22) Filed: Aug. 9, 2012

(51) Int. Cl. G06Q 50/24

(52) U.S. Cl. 705/3

(57) ABSTRACT

Techniques, systems, and devices, for generating a patient management report based on clinician input and patient data are described. For example, one or more processors may be configured to receive a clinician input selecting at least one reporting characteristic for each of a plurality of diagnostic metrics and organize the diagnostic metrics based on the selected reporting characteristic. In addition, the one or more processors may be configured to receive patient data for at least one patient, determine a value for at least a subset of the diagnostic metrics based on the patient data, and generate a patient management report comprising the diagnostic metrics having a value that exceeds a respective threshold. The diagnostic metrics may be ordered in the patient management report based on the organization.

### TECHNICAL FIELD

The invention relates to patient health, and, more particularly, to devices and techniques that manage and distribute patient data.

### BACKGROUND

The capacity of various types of implantable medical devices to collect and store data has increased in recent years. These devices include microprocessors for processing collected data for various purposes. The devices may process the collected data to detect and classify sensed episodes which may be characteristic of certain patient conditions (e.g., cardiac arrhythmias). The patient may benefit from the delivery of therapy, and the processed data may guide treatment of the patient, such as therapy delivered by a device, to address one or more of the patient conditions.

In some examples, the processed data may be used as closed loop feedback for adjusting one or more parameters of the therapy (e.g., one or more therapy parameters that define electrical stimulation delivered by the device). In other examples, the processed data may be reviewed by a clinician to manually determine any patient conditions and appropriate therapy. The processed data may be stored in a memory for later retrieval and/or transmitted to another device for access by the clinician.

### SUMMARY

Generally, this disclosure describes techniques, systems, and devices, for generating a patient management report based on clinician input and patient data. The patient management report is a tool that clinicians may use in triaging, diagnosing, and/or managing one or more patients being treated for a condition or who may be at risk for developing a condition. The patient management report may be customized using clinician input that selects at least one reporting characteristic for each diagnostic metric that may be included in the report. The reporting characteristics may identify how the diagnostic metrics can be organized (e.g., ranked, grouped, or sorted) to facilitate triaging conditions from one patient or multiple patients.

An implantable medical device (IMD), e.g., a pacemaker, cardioverter and/or defibrillator, or a monitor that does not provide therapy, may automatically generate and store patient data used to generate the patient management report. Patient data from an IMD may include therapy use statistics (e.g., statistics related to the delivery of pacing or shocks to the patient), heart rate, heart rate variability, patient activity, ventricular arrhythmias, atrial arrhythmias, and cardiac resynchronization therapy percentages. Clinic history, therapy history, patient condition status, and any other patient information related to the diagnosis and treatment of a patient may be stored by the IMD, a programmer, or other database. Diagnostic metrics may be determined or calculated, based on sensed patient data from the IMD and/or patient information entered by a clinician, to identify potential problems or issues with the IMD, the patient, or any treatment being delivered to the patient. A diagnostic metric may be presented in the patient management report when a value of a diagnostic metric exceeds a respective threshold.

In one example, the disclosure describes a method that includes receiving a clinician input selecting at least one reporting characteristic for each of a plurality of diagnostic metrics, organizing, by one or more processors, the diagnostic metrics based on the selected reporting characteristic, receiving patient data for at least one patient, determining a value for at least a subset of the diagnostic metrics based on the patient data, and generating, by the one or more processors, a patient management report comprising the diagnostic metrics having a value that exceeds a respective threshold, wherein the diagnostic metrics are ordered in the patient management report based on the organization.

In another example, the disclosure describes a system that includes one or more processors configured to receive a clinician input selecting at least one reporting characteristic for each of a plurality of diagnostic metrics, organize the diagnostic metrics based on the selected reporting characteristic, receive patient data for at least one patient, determine a value for at least a subset of the diagnostic metrics based on the patient data, and generate a patient management report comprising the diagnostic metrics having a value that exceeds a respective threshold, wherein the diagnostic metrics are ordered in the patient management report based on the organization.

In another example, the disclosure describes a computer-readable storage medium comprising instructions that cause one or more processors to receive a clinician input selecting at least one reporting characteristic for each of a plurality of diagnostic metrics, organize the diagnostic metrics based on the selected reporting characteristic, receive patient data for at least one patient, determine a value for at least a subset of the diagnostic metrics based on the patient data, and generate a patient management report comprising the diagnostic metrics having a value that exceeds a respective threshold, wherein the diagnostic metrics are ordered in the patient management report based on the organization.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual drawing illustrating an example system configured to collect and transmit patient data that includes an implantable medical device (IMD) coupled to implantable medical leads.

FIG. 2A is a conceptual drawing illustrating the example IMD and leads of FIG. 1 in conjunction with a heart.

FIG. 2B is a conceptual drawing illustrating the example IMD of FIG. 1 coupled to a different configuration of implantable medical leads in conjunction with a heart.

FIG. 3 is a block diagram illustrating an example system that includes the external device of FIG. 6, and one or more computing devices that are coupled to the IMD and programmer shown in FIG. 1 via a network.

FIG. 4 is a functional block diagram illustrating an example configuration of the IMD of FIG. 1.

FIG. 5 is a functional block diagram illustrating an example configuration of an external programmer that facilitates user communication with the IMD.

FIG. 6 is a functional block diagram illustrating an example configuration of an external device, such as a server, configured to generate a patient management report.

FIG. 7 illustrates an example user interface that includes a clinician survey for receiving clinician input related to diagnostic metrics.

FIG. 8 illustrates an example user interface that includes input fields for customizing content and/or delivery of a patient management report to a clinician.

FIG. 9 illustrates an example user interface that includes composite reporting characteristics generated from multiple clinician surveys for a plurality of diagnostic metrics.

FIG. 10 illustrates an example user interface that includes a patient management report.

FIG. 11 is a flow diagram of an example technique for generating a patient management report from patient data.

FIG. 12 is a flow diagram of an example technique for receiving clinician input for generating composite reporting characteristics for diagnostic metrics.

FIG. 13 is a flow diagram of an example technique for presenting an interactive patient management report to a clinician.

### DETAILED DESCRIPTION

This disclosure describes techniques, systems, and devices, for generating a patient management report based on clinician input and patient data. Clinicians (e.g., physicians, nurses, and other healthcare personnel) typically manage several to hundreds of patients at any given time. In many cases, the course of treatment may occur while patients are away from a clinical or hospital setting. The challenge of treating many patients without frequent personal contact may make it difficult to provide the most timely treatments, or changes in treatment, to each patient.

In some situations, remote patients may have one or more medical devices (e.g., implanted or external devices) monitoring and/or treating one or more conditions. These medical devices may be capable of transmitting information via a network or other communication pathway to the clinician. Although this transmitted information may facilitate more timely information about the patient than would be otherwise possible, the clinician may not be able to effectively synthesize the information to manage each patient. The obtained information regarding each patient may thus not facilitate efficacious treatment unless the information from each patient is managed (e.g., sorted, organized, or triaged) for the clinician.

As described herein, a patient management report may be generated and provided as a tool for clinicians to use in triaging, diagnosing, and/or managing one or more patients. The patient management report may include diagnostic metrics that indicate a patient condition, event, or other information representative of any changes to the patient. The patient management report may also be customized using clinician input that selects at least one reporting characteristic for each diagnostic metric that may be included in the report. The reporting characteristics may identify how the diagnostic metrics can be organized (e.g., ordered, ranked, grouped, or sorted) to facilitate triaging conditions from one patient or multiple patients using the patient management report. The organization of the reporting characteristics may determine how two or more diagnostic metrics are ordered in the patient management report when the report is generated.

Diagnostic metrics that may be included in the patient management report may incorporate sensed data from an implantable or external medical device (e.g., patient data). For example, an implantable medical device (IMD) (e.g., a pacemaker, cardioverter and/or defibrillator, or a monitor that does not provide therapy) may automatically generate and store patient data used to generate the patient management report. Patient data from an IMD may include therapy use statistics (e.g., pacing or shocks), heart rate, heart rate variability, patient activity, atrial arrhythmias, and cardiac resynchronization therapy percentages. Patient information may include clinic history (e.g., procedures, therapies, diagnoses, and/or laboratory results), therapy history (e.g., detailed instances of delivered therapy, dosages of therapies, parameters defining therapy, and/or results of delivered therapies), patient condition status (e.g., current patient conditions indicated by device collected values or clinician observed values), and any other patient information related to the diagnosis and treatment of a patient may be stored by the IMD, a programmer, or other database.

Although diagnostic metrics may include sensed data from a device, the diagnostic metrics may also incorporate patient history or other patient information (such as described above) entered by the clinician or created by another device. In this manner, in one example, a diagnostic metric may be determined based on sensed patient data from the IMD and/or patient information entered by a clinician. One or more diagnostic metrics may then be representative of a synthesis of sensed data and other information stored for the patient. For example, a diagnostic metric may incorporate sensed data indicating that ventricular tachycardia has occurred in the patient and stored information indicating the patient as a primary prevention patient to indicate when the first ventricular tachycardia has occurred within a primary prevention patient. This clinically relevant automatic observation from a diagnostic metric may help to synthesize the vast quantity of data available on a patient.

The patient management report may include diagnostic metrics from one or more patients. In some examples, a diagnostic metric for a patient may be presented in the patient management report when a value of the diagnostic metric exceeds a respective threshold. However, the clinician may provide input that customizes the patient management report such that only new diagnostic metrics (e.g., metrics that change to exceed their respective threshold since the last patient management report) are displayed. Further, based on selected reporting characteristics from the clinician, the diagnostic metrics may be organized (e.g., ordered or ranked) to triage patients or otherwise guide the clinician in addressing each patient identified within the patient management report.

The patient management report may be generated by a computing device that has access to the sensed data (e.g., data generated by an IMD) and other patient information. For example, the patient management report may be generated by a server and delivered to the clinician over a network in response to diagnostic metrics exceeding a threshold, on demand from the clinician, or according to a predetermined delivery schedule. The server may receive and/or store data from multiple sources (e.g., sensed data from an IMD, programmed information from a programmer, and/or clinically entered information from a clinician). In other examples, a clinician programmer or other computing device may analyze patient data and generate the patient management report.

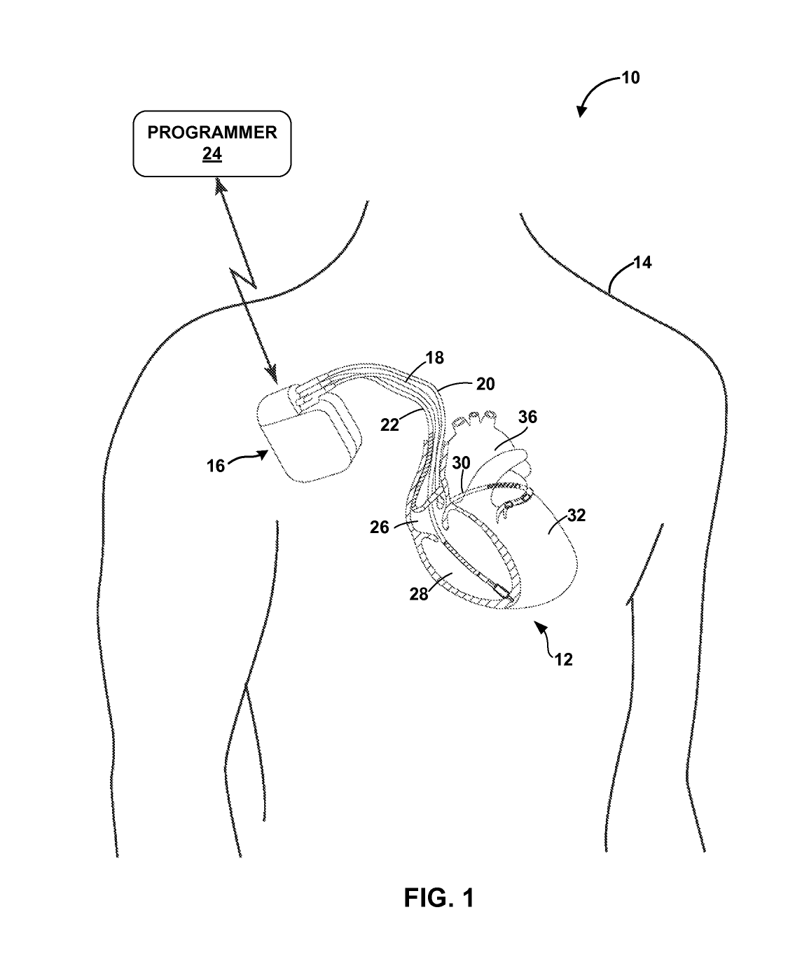

FIG. 1 is a conceptual drawing illustrating an example system 10 configured to collect and transmit patient data from patient 14 for generation of a patient management report. In the example of FIG. 1, system 10 includes IMD 16, which is coupled to leads 18, 20, and 22 and programmer 24. IMD 16 may be, for example, an implantable pacemaker, cardioverter, and/or defibrillator that provides electrical signals to heart 12 via electrodes coupled to one or more of leads 18, 20, and 22. Patient 14 is ordinarily, but not necessarily a human patient.

Although an implantable medical device and delivery of electrical stimulation to heart 12 are described herein as examples, the techniques for generating diagnostic metrics using sensed patient data and other information for a patient management report may be applicable to other medical devices and/or other therapies. In general, the techniques described in this disclosure may be implemented by any medical device, e.g., implantable or external, that senses a signal indicative of cardiac activity, patient activity, or some other physiological or anatomical activity of patient 14. As one alternative example, the techniques described herein may be implemented in an implanted or external cardiac monitor that generates electrograms of heart 12 and detects thoracic fluid volumes, respiration, and/or cardiovascular pressure of patient 14.

In the example of FIG. 1, leads 18, 20, 22 extend into the heart 12 of patient 14 to sense electrical activity of heart 12 and/or deliver electrical stimulation to heart 12. Leads 18, 20, and 22 may also be used to detect a thoracic impedance indicative of fluid volume in patient 14, respiration rates, sleep apnea, electrical events, or other sensed data used to determine the diagnostic metrics. Respiration metrics, e.g., respiration rates, tidal volume, and sleep apnea, may also be detectable via an electrogram, e.g., based on a signal component in a cardiac electrogram that is associated with respiration. In the example shown in FIG. 1, right ventricular (RV) lead 18 extends through one or more veins (not shown), the superior vena cava (not shown), and right atrium 26, and into right ventricle 28. Left ventricular (LV) coronary sinus lead 20 extends through one or more veins, the vena cava, right atrium 26, and into the coronary sinus 30 to a region adjacent to the free wall of left ventricle 32 of heart 12. Right atrial (RA) lead 22 extends through one or more veins and the vena cava, and into the right atrium 26 of heart 12.

In some examples, system 10 may additionally or alternatively include one or more leads or lead segments (not shown in FIG. 1) that deploy one or more electrodes within the vena cava, or other veins. Furthermore, in some examples, system 10 may additionally or alternatively include temporary or permanent epicardial or subcutaneous leads with electrodes implanted outside of heart 12, instead of or in addition to transvenous, intracardiac leads 18, 20 and 22. Such leads may be used for one or more of cardiac sensing, pacing, or cardioversion/defibrillation. For example, these electrodes may allow alternative electrical sensing configurations that provide improved or supplemental sensing in some patients. In other examples, these other leads may be used to detect intrathoracic impedance for a diagnostic metric related to heart failure risk or fluid retention levels.

IMD 16 may sense electrical signals attendant to the depolarization and repolarization of heart 12 via electrodes (not shown in FIG. 1) coupled to at least one of the leads 18, 20, 22. In some examples, IMD 16 provides pacing pulses to heart 12 based on the electrical signals sensed within heart 12. The configurations of electrodes used by IMD 16 for sensing and pacing may be unipolar or bipolar. IMD 16 may detect arrhythmia of heart 12, such as tachycardia or fibrillation of the atria 26 and 36 and/or ventricles 28 and 32, and may also provide defibrillation therapy and/or cardioversion therapy via electrodes located on at least one of the leads 18, 20, 22. In some examples, IMD 16 may be programmed to deliver a progression of therapies, e.g., pulses with increasing energy levels, until a fibrillation of heart 12 is stopped. IMD 16 may detect fibrillation employing one or more fibrillation detection techniques known in the art.

In addition, IMD 16 may monitor the electrical signals of heart 12 for one or more diagnostic metrics used in monitoring patient 14, treating patient 14, and/or generating the patient management report. IMD 16 may utilize two of any electrodes carried on leads 18, 20, 22 to generate electrograms of cardiac activity. In some examples, IMD 16 may also use a housing electrode of IMD 16 (not shown) to generate electrograms and monitor cardiac activity. Although these electrograms may be used to monitor heart 12 for potential arrhythmias and other disorders for therapy, the electrograms may also be used to monitor the condition of heart 12. For example, IMD 16 may monitor heart rate (night time and day time), heart rate variability, ventricular or atrial intrinsic pacing rates, indicators of blood flow, or other indicators of the ability of heart 12 to pump blood or the progression of heart failure.

In some examples, IMD 16 may also use any two electrodes of leads 18, 20, and 22 or the housing electrode to sense the intrathoracic impedance of patient 14. As the tissues within the thoracic cavity of patient 14 increase in fluid content, the impedance between two electrodes may also change. For example, the impedance between an RV coil electrode and the housing electrode may be used to monitor changing intrathoracic impedance.

IMD 16 may use this impedance to create a fluid index. As the fluid index increases, more fluid is being retained within patient 14 and heart 12 may be stressed to keep up with moving the greater amount of fluid. Therefore, this fluid index may be used for a diagnostic metric. By monitoring the fluid index in addition to other sensed values, IMD 16 may be able to reduce the number of false positive heart failure identifications relative to what might occur when monitoring only one or two values indicative of the patient condition. An example system for measuring thoracic impedance and determining a fluid index is described in U.S. Patent Publication No. 2010/0030292 to Sarkar et al., entitled, “DETECTING WORSENING HEART FAILURE BASED ON IMPEDANCE MEASUREMENTS,” which published on Feb. 4, 2010 and is incorporated herein by reference in its entirety.

IMD 16 may also communicate with external programmer 24. In some examples, programmer 24 comprises an external device, e.g., a handheld computing device, computer workstation, or networked computing device (e.g., a mobile device or a network access point). Programmer 24 may include a user interface that receives input from a user. In other examples, the user may also interact with programmer 24 remotely via a networked computing device. The user may interact with programmer 24 to communicate with IMD 16. For example, the user may interact with programmer 24 to send an interrogation request and retrieve sensed data or other information from IMD 16. A user may also interact with programmer 24 to program IMD 16, e.g., select values for operational parameters of IMD 16. Although the user is a physician, technician, surgeon, electrophysiologist, or other healthcare professional, the user may be patient 14 in some examples.

For example, IMD 16 may transmit sensed data or other patient data stored on IMD 16 to programmer 24. IMD 16 may transmit the data in response to receiving a request from programmer 24, in response to obtaining patient data, when a communication channel is established between IMD 16 and programmer 24, or according to a predetermined schedule (e.g., hourly, daily, or weekly). For example, IMD 16 may transmit electrical signals (e.g., an electrocardiogram (ECG)) detected from heart 12, electrical events identified from the ECG (e.g., ventricular or atrial tachycardia, or ventricular or atrial fibrillation), patient activity values, heart rate, respiration rate, or any other sensed data or information generated from the sensed data. In addition, IMD 16 may transmit information regarding treatment delivered to patient 14. For example, IMD 16 may transmit information regarding shocks delivered to patient 14 (e.g., the number of shocks, parameters of each shock, and timeline of each shock), pacing parameters, stimulation parameters, drug delivery parameters, or any other information related to therapies delivered by IMD 16. The data or information transmitted by IMD 16 may be directed to any data obtained by IMD 16 or only information used to generate the diagnostic metrics provided in the patient management report. IMD 16 may automatically sense values from one or more parameters and store them within the IMD for later transmission.

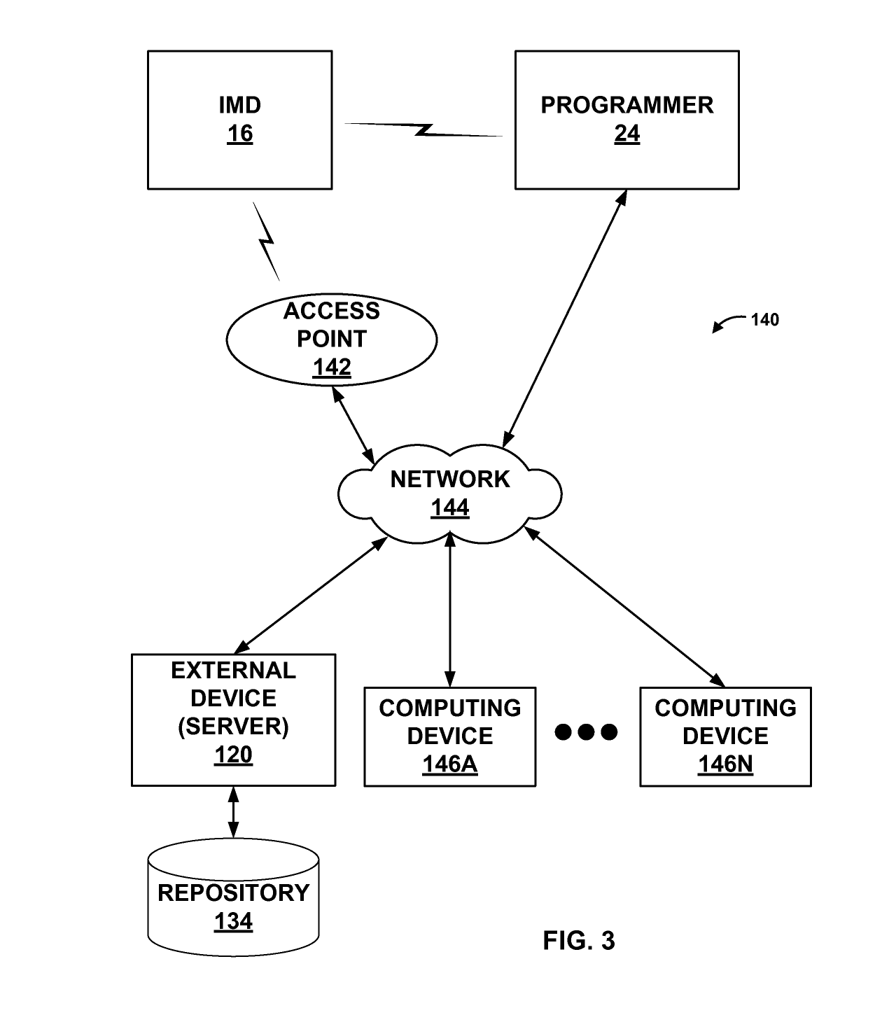

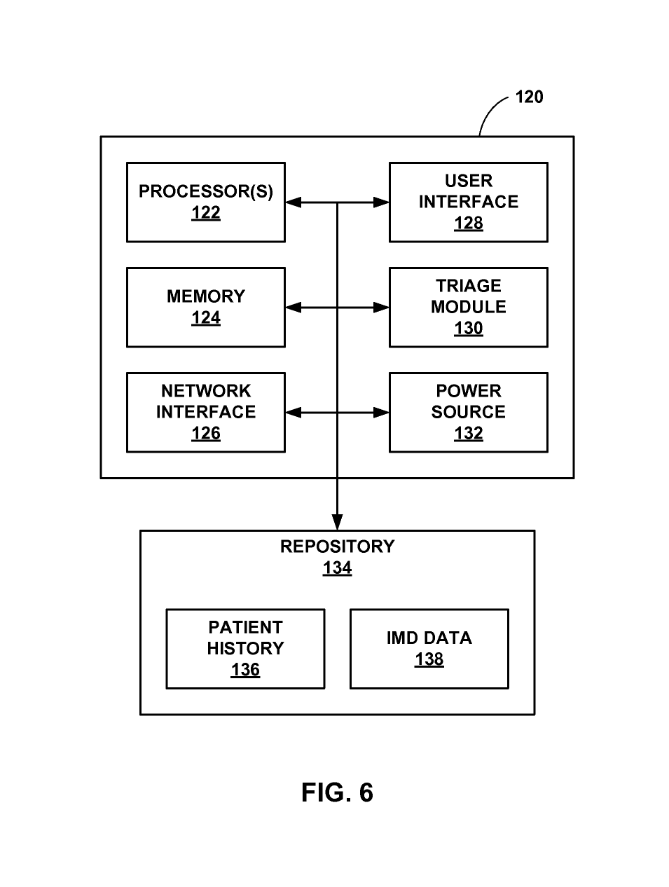

As another example, the programmer 24 may retrieve information from IMD 16 regarding the performance or integrity of IMD 16 or other components of system 10, such as leads 18, 20 and 22, or a power source of IMD 16. This data regarding the function of IMD 16 may be transmitted in raw form and/or processed for use in generating one or more diagnostic metrics. IMD 16 may transmit this information as it is obtained, as it is requested by programmer 24, or according to a predetermined transmission schedule. Programmer 24 may transmit any information received from IMD 16 to a remote sever via a network for processing, analysis, generation of the patient management report, and/or presentation to a clinician. In other examples, a home monitor different from programmer 24 or other access point (e.g., access point 142 of FIG. 3) may receive information from IMD 16 and/or transmit the information to a server (e.g., server 120 of FIGS. 3 and 6).

Programmer 24 may also allow the user to define how IMD 16 senses, detects, and/or manages patient data. For example, the user may define the frequency of sampling or the evaluation window used to monitor the various values from sensed parameters. In some examples, the user may use programmer 24 to select which diagnostic metrics are desired to be sent, characteristics of each diagnostic metric, or even set the threshold for one or more diagnostic metrics. In this manner, programmer 24 may be used to customize how diagnostic metrics are generated and when diagnostic metrics are included within a patient management report. In other examples, the user (e.g., a clinician) may use an alternative computing device in communication with a server to manage diagnostic metrics, determine how each diagnostic metric is calculated, select reporting characteristics for each diagnostic metric, and/or set thresholds for each diagnostic metric. The threshold for each diagnostic metric may determine when the diagnostic metric is presented in a patient management report (e.g., the diagnostic metric may only be presented within the patient management report when the metric exceeds the respective threshold).

Patient data or information not generated from IMD 16 or another implanted device may also be incorporated into a diagnostic metric. This information (e.g., non-device information) may include patient history, patient entered information (e.g., responses to questionnaires or entries into a patient diary), clinician entered information, or other information related to the patient or patient condition. Example information may include patient weight, medication compliance, consumed food, liquid intake, activity durations, pain levels, pain locations, urinary or fecal voiding events, durations of treatment, allergies, or any other non-device information that may describe or otherwise characterize the health of patient 14. The non-device information may be stored in IMD 16, programmer 24, or a remote repository via a network.

IMD 16 and programmer 24 may communicate via wireless communication using any techniques known in the art. Examples of communication techniques may include, for example, radiofrequency (RF) telemetry (e.g., Bluetooth communication or near-field communication), but other communication techniques such as magnetic coupling are also contemplated. In some examples, programmer 24 may include a programming head that may be placed proximate to the body of the patient near the IMD 16 implant site in order to improve the quality or security of communication between IMD 16 and programmer 24.

The patient data collected from IMD 16 and/or other patient information may be synthesized to generate one or more diagnostic metrics, e.g., values of diagnostic metrics may be computed based on the patient data collected from IMD 16 and/or other patient information. Each diagnostic metric may be used to indicate one or more changes in the patient condition or events that the patient has endured. In this manner, the diagnostic metrics may be used by the clinician to change a course of treatment for a patient. In addition, each diagnostic metric may have a reporting characteristic that is used to organize the metric amongst other diagnostic metrics. For example, the reporting characteristic may be an urgency, type of action to take, or a treatment time for the diagnostic metric. The diagnostic metrics may be ranked or grouped according to one or more reporting characteristic. In this manner, the patient management report may triage (e.g., order) the diagnostic metrics, and associated patients, for the clinician. In some examples, the ordering of the diagnostic metrics may highlight or prioritize certain diagnostic metrics over other diagnostic metrics.

IMD 16 may initialize transmission of patient data to programmer 24 and/or another computing device. In other examples, programmer 24 or another remote device may remotely interrogate IMD 16 for one or more patients. In response to the interrogation, IMD 16 may transmit the requested patient data and/or perform one or more sensing function. Therefore, the interrogating device may retrieve up-to-date information from IMD 16 when a patient management report is requested by a clinician or the patient management report is otherwise scheduled to be generated.

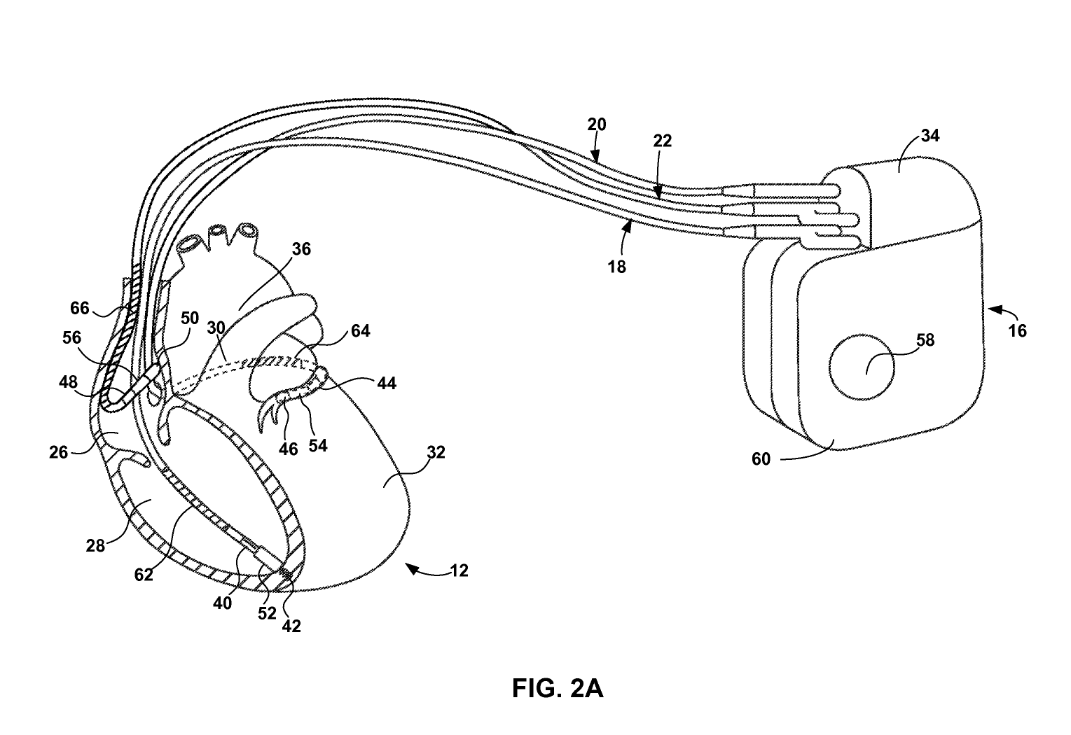

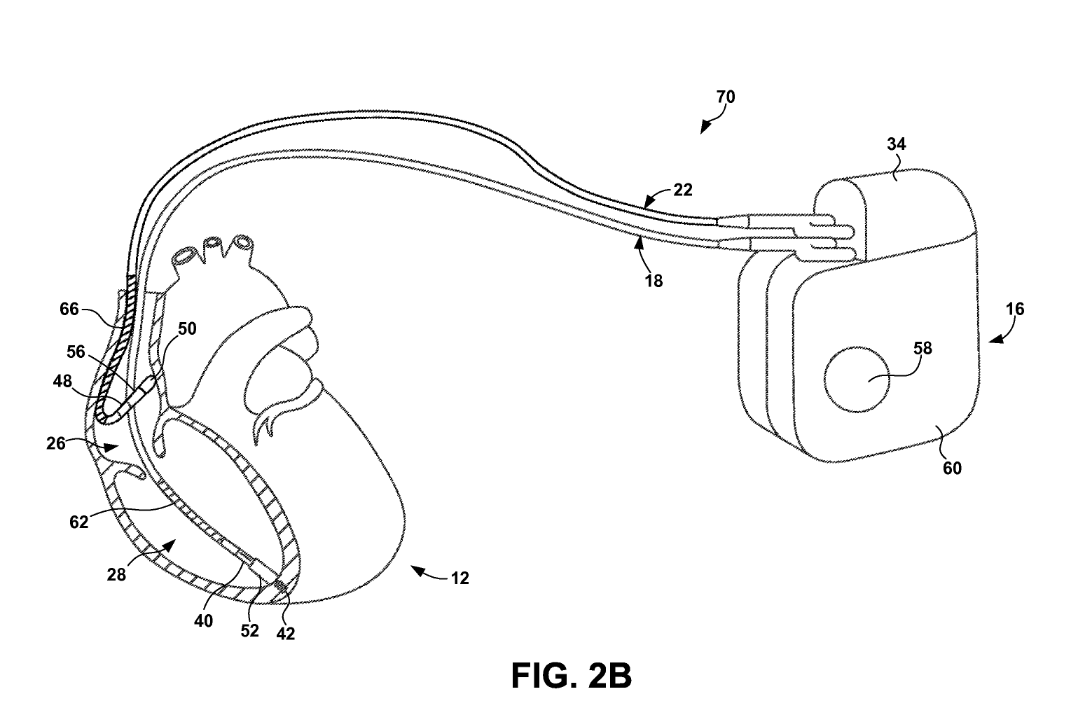

FIG. 2A is a conceptual drawing illustrating IMD 16 and leads 18, 20, and 22 of system 10 in greater detail. As shown in FIG. 2A, IMD 16 is coupled to leads 18, 20, and 22. Leads 18, 20, 22 may be electrically coupled to a signal generator, e.g., stimulation generator, and a sensing module of IMD 16 via connector block 34. In some examples, proximal ends of leads 18, 20, 22 may include electrical contacts that electrically couple to respective electrical contacts within connector block 34 of IMD 16. In addition, in some examples, leads 18, 20, 22 may be mechanically coupled to connector block 34 with the aid of set screws, connection pins, snap connectors, or another suitable mechanical coupling mechanism.

Each of the leads 18, 20, 22 includes an elongated insulative lead body, which may carry a number of concentric coiled conductors separated from one another by tubular insulative sheaths. Bipolar electrodes 40 and 42 are located adjacent to a distal end of lead 18 in right ventricle 28. In addition, bipolar electrodes 44 and 46 are located adjacent to a distal end of lead 20 in coronary sinus 30 and bipolar electrodes 48 and 50 are located adjacent to a distal end of lead 22 in right atrium 26. In the illustrated example, there are no electrodes located in left atrium 36. However, other examples may include electrodes in left atrium 36.

Electrodes 40, 44, and 48 may take the form of ring electrodes, and electrodes 42, 46 and 50 may take the form of extendable helix tip electrodes mounted retractably within insulative electrode heads 52, 54 and 56, respectively. In other examples, one or more of electrodes 42, 46 and 50 may take the form of small circular electrodes at the tip of a tined lead or other fixation element. Leads 18, 20, 22 also include elongated electrodes 62, 64, 66, respectively, which may take the form of a coil. Each of the electrodes 40, 42, 44, 46, 48, 50, 62, 64 and 66 may be electrically coupled to a respective one of the coiled conductors within the lead body of its associated lead 18, 20, 22, and thereby coupled to respective ones of the electrical contacts on the proximal end of leads 18, 20 and 22.

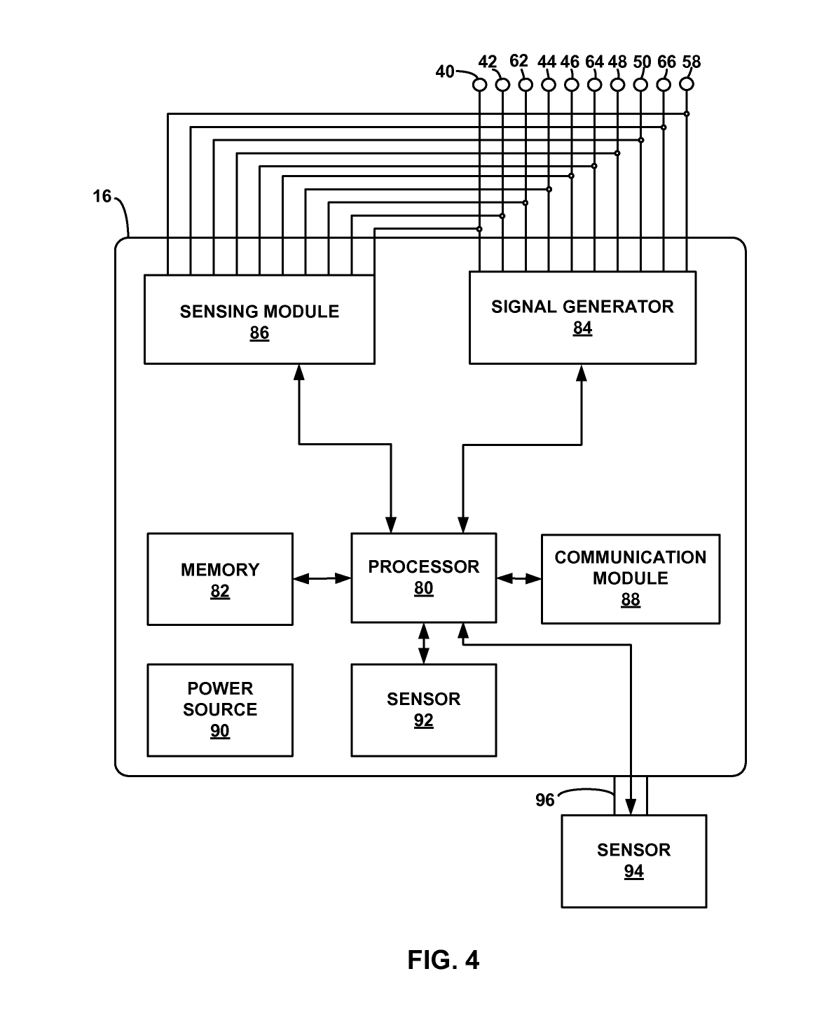

In some examples, as illustrated in FIG. 2A, IMD 16 includes one or more housing electrodes, such as housing electrode 58, which may be formed integrally with an outer surface of hermetically-sealed housing 60 of IMD 16, or otherwise coupled to housing 60. In some examples, housing electrode 58 is defined by an uninsulated portion of an outward facing portion of housing 60 of IMD 16. Other division between insulated and uninsulated portions of housing 60 may be employed to define two or more housing electrodes. In some examples, housing electrode 58 comprises substantially all of housing 60. As described in further detail with reference to FIG. 4, housing 60 may enclose a signal generator that generates therapeutic stimulation, such as cardiac pacing pulses and defibrillation shocks, as well as a sensing module for monitoring the rhythm of heart 12.

IMD 16 may sense electrical signals attendant to the depolarization and repolarization of heart 12 via electrodes 40, 42, 44, 46, 48, 50, 62, 64 and 66. The electrical signals are conducted to IMD 16 from the electrodes via the respective leads 18, 20, 22. IMD 16 may sense such electrical signals via any bipolar combination of electrodes 40, 42, 44, 46, 48, 50, 62, 64 and 66. Furthermore, any of the electrodes 40, 42, 44, 46, 48, 50, 62, 64 and 66 may be used for unipolar sensing in combination with housing electrode 58. The combination of electrodes used for sensing may be referred to as a sensing configuration or electrode vector.

In some examples, IMD 16 delivers pacing pulses via bipolar combinations of electrodes 40, 42, 44, 46, 48 and 50 to produce depolarization of cardiac tissue of heart 12. In some examples, IMD 16 delivers pacing pulses via any of electrodes 40, 42, 44, 46, 48 and 50 in combination with housing electrode 58 in a unipolar configuration. Furthermore, IMD 16 may deliver defibrillation pulses to heart 12 via any combination of elongated electrodes 62, 64, 66, and housing electrode 58. Electrodes 58, 62, 64, 66 may also be used to deliver cardioversion pulses to heart 12. Electrodes 62, 64, 66 may be fabricated from any suitable electrically conductive material, such as, but not limited to, platinum, platinum alloy or other materials known to be usable in implantable defibrillation electrodes. The combination of electrodes used for delivery of stimulation or sensing, their associated conductors and connectors, and any tissue or fluid between the electrodes, may define an electrical path.

The configuration of system 10 illustrated in FIGS. 1 and 2A is merely one example. In other examples, a system may include epicardial leads and/or subcutaneous electrodes instead of or in addition to the transvenous leads 18, 20, 22 illustrated in FIG. 1. Further, IMD 16 need not be implanted within patient 14. In examples in which IMD 16 is not implanted in patient 14, IMD 16 may sense electrical signals and/or deliver defibrillation pulses and other therapies to heart 12 via percutaneous leads that extend through the skin of patient 14 to a variety of positions within or outside of heart 12. Further, external electrodes or other sensors may be used by IMD 16 to deliver therapy to patient 14 and/or sense and detect values of patient parameters used to generate one or more diagnostic metrics for patient 14.

In addition, in other examples, a system may include any suitable number of leads coupled to IMD 16, and each of the leads may extend to any location within or proximate to heart 12. For example, systems in accordance with this disclosure may include three transvenous leads located as illustrated in FIGS. 1 and 2A, and an additional lead located within or proximate to left atrium 36. As another example, systems may include a single lead that extends from IMD 16 into right atrium 26 or right ventricle 28, or two leads that extend into a respective one of the right ventricle 26 and right atrium 26. An example of a two lead type of system is shown in FIG. 2B. Any electrodes located on these additional leads may be used in sensing and/or stimulation configurations.

Any of electrodes 40, 42, 44, 46, 48, 50, 62, 64, 66, and 58 may be utilized by IMD 16 to sense or detect values of parameters used to generate diagnostic metrics for patient 14. Typically, IMD 16 may detect and collect patient data from those electrode vectors used to treat patient 14. For example, IMD 16 may derive an atrial fibrillation duration, heart rate, and heart rate variability value from electrograms generated to deliver pacing therapy. However, IMD 16 may utilize other electrodes to detect values for these types of parameters from patient 14 when other electrical signals may be more appropriate for therapy.

In addition to electrograms of cardiac signals, any of electrodes 40, 42, 44, 46, 48, 50, 62, 64, 66, and 58 may be used to sense non-cardiac signals. For example, two or more electrodes may be used to measure an impedance within the thoracic cavity of patient 14. This intrathoracic impedance may be used to generate a fluid index parameter that indicates the amount of fluid building up within patient 14. Since a greater amount of fluid may indicate increased pumping loads on heart 12, the fluid index may be used as an indicator of heart failure risk. IMD 16 may periodically measure the intrathoracic impedance to identify a trend in the fluid index over days, weeks, months, and even years of patient monitoring.

In general, the two electrodes used to measure the intrathoracic impedance may be located at two different positions within the chest of patient 14. For example, coil electrode 62 and housing electrode 58 may be used as the sensing vector for intrathoracic impedance because electrode 62 is located within RV 28 and housing electrode 58 is located at the IMD 16 implant site generally in the upper chest region. However, other electrodes spanning multiple organs or tissues of patient 14 may also be used, e.g., an additional implanted electrode used only for measuring thoracic impedance.

FIG. 2B is a conceptual diagram illustrating another example system 70, which is similar to system 10 of FIGS. 1 and 2, but includes two leads 18, 22, rather than three leads. Leads 18, 22 are implanted within right ventricle 28 and right atrium 26, respectively. System 70 shown in FIG. 2B may be useful for physiological sensing and/or providing pacing, cardioversion, or other therapies to heart 12. Detection of one or more patient parameters and transmission of patient data according to this disclosure may be performed in two lead systems in the manner described herein with respect to three lead systems. In other examples, a system similar to systems 10 and 70 may only include one lead (e.g., any of leads 18, 20 or 22) to deliver therapy and/or sensor and detect patient parameters related to monitoring risk of heart failure, arrhythmias, or any other patient condition. Alternatively, systems utilizing subcutaneous leads, subcutaneous IMDs, or even external medical devices may generate patient data that is used to generate diagnostic metrics and patient management reports.

FIG. 3 is a block diagram illustrating an example system 140 that includes an external device, such as a server 120, and one or more computing devices 146A-146N, that are coupled to the IMD 16 and programmer 24 shown in FIG. 1 via a network 144. Network 144 may be generally used to transmit clinician input, patient data, diagnostic metrics, patient management reports, or any other information between any devices of system 140. Network 144 may allow the clinician to monitor and/or treat patients remote from the clinician. In this example, IMD 16 may use its communication module 88 to communicate with programmer 24 via a first wireless connection, and to communication with an access point 142 via a second wireless connection. In the example of FIG. 3, access point 142, programmer 24, server 120, and computing devices 146A-146N are interconnected, and able to communicate with each other, through network 144. In some cases, one or more of access point 142, programmer 24, server 120, and computing devices 146A-146N may be coupled to network 144 through one or more wireless connections. IMD 16, programmer 24, server 120, and computing devices 146A-146N may each comprise one or more processors, such as one or more microprocessors, DSPs, ASICs, FPGAs, programmable logic circuitry, or the like, that may perform various functions and operations, such as those described herein.

Access point 142 may comprise a device that connects to network 144 via any of a variety of connections, such as telephone dial-up, digital subscriber line (DSL), or cable modem connections. In other examples, access point 142 may be coupled to network 144 through different forms of connections, including wired or wireless connections. In some examples, access point 142 may be co-located with patient 14 and may comprise one or more programming units and/or computing devices (e.g., one or more portable or home monitoring units) that may perform various functions and operations described herein. For example, access point 142 may include a home-monitoring unit that is co-located with patient 14 and that may monitor the activity of IMD 16 (e.g., receive information or data from IMD 16) and/or receive patient data used by server 120 to generate diagnostic metrics. In some examples, server 120 or computing devices 146 may control or perform any of the various functions or operations described herein, e.g., generate a patient management report, compare diagnostic metrics to respective thresholds, and receive clinician input that customizes one or more aspects of the patient management report.

Computing devices 146 may include tablet computers, workstations, notebook computers, mobile phones, personal digital assistants, or any other computing device that may be used by a healthcare professional to monitor and/or treat a patient. For example, computing device 146A may be carried by a clinician tasked with monitoring the health of one or more patients. Computing device 146A, or any other computing device 146, may present the patient management report as a centralized information source about the patients that the clinician is tracking. The clinician may use the patient management report as a way to triage patients without separately reviewing data from each patient periodically. The patient management report may be delivered as a web page through a web browser, within a specific software application, or in any other digital format. In other examples, the clinician may receive the patient management report as a printed report instead of an interactive or non-interactive digital report via computing device 146A.

The patient management report may be generated and delivered periodically. For example, server 120 may generate the patient management report on a daily basis at a time requested by the clinician and delivered to one or more computing devices 146. In other examples, the patient management report may be delivered to a clinician account managed by server 120. When the clinician logs into the clinician account from any computing device or programmer, server 120 may deliver the patient management report or notify the clinician that a new patient management report is available. The periodic delivery of patient management reports may instead be performed hourly or at some other predetermined interval set by a clinic, the clinician, a manufacturer of IMD 16, or an account manager of server 120. In other examples, patient management reports may be generated in response to a request from the clinician or in response to one or more new diagnostic metrics that may indicate urgent attention by the clinician is necessary.

Customization of the patient management reports may be updated by a clinician from one or more devices (e.g., computing devices 146 or programmer 24) that have access to server 120 via network 144. Server 120 may maintain a clinician account for each clinician associated with server 120. Anytime server 120 receives clinician input identifying an updated preference or set of preferences, server 120 may update the appropriate preferences in the clinician account. These preferences received from the clinician may include selected reporting characteristics, patient management report delivery timing, which diagnostic metrics to include, or even when to hide certain diagnostic metrics from the patient management report (e.g., only including diagnostic metrics not previously presented in a patient management report to the clinician such that continual patient conditions do not bury new issues from one or more patients).

In some cases, repository 134 may be configured to provide a secure storage site for archival of patient information (e.g., patient history 136 or sensed IMD data 138) that has been collected from IMD 16, programmer 24, computing devices 146, and/or any other device. Network 144 may comprise a local area network, wide area network, or global network, such as the Internet. In some cases, programmer 24 or server 120 may generate the patient management reports in web pages or other documents for viewing by and trained professionals, such as clinicians, via viewing terminals associated with computing devices 146. The system of FIG. 3 may be implemented, in some aspects, with general network technology and functionality similar to that provided by the Medtronic CareLink® Network developed by Medtronic, Inc., of Minneapolis, Minn.

FIG. 4 is a functional block diagram illustrating an example configuration of IMD 16. In the illustrated example, IMD 16 includes a processor 80, memory 82, signal generator 84, sensing module 86, communication module 88, power source 90, and sensors 92 and 94. Memory 82 includes computer-readable instructions that, when executed by processor 80, cause IMD 16 and processor 80 to perform various functions attributed to IMD 16 and processor 80 herein. Memory 82 may include any volatile, non-volatile, magnetic, optical, or electrical storage media, such as a random access memory (RAM), read-only memory (ROM), non-volatile RAM (NVRAM), electrically-erasable programmable ROM (EEPROM), flash memory, or any other digital or analog storage media.

Processor 80 may include any one or more of a microprocessor, a controller, a digital signal processor (DSP), an application specific integrated circuit (ASIC), a field-programmable gate array (FPGA), or equivalent discrete or analog logic circuitry. In some examples, processor 80 may include multiple components, such as any combination of one or more microprocessors, one or more controllers, one or more DSPs, one or more ASICs, or one or more FPGAs, as well as other discrete or integrated logic circuitry. The functions attributed to processor 80 herein may be embodied as software, firmware, hardware or any combination thereof. Processor 80 may control signal generator 84 to deliver stimulation therapy to heart 12 according to a therapy parameters, which may be stored in memory 82. For example, processor 80 may control signal generator 84 to deliver electrical pulses with the amplitudes, pulse widths, frequency, or electrode polarities specified by the therapy parameters.

Signal generator 84 is electrically coupled to electrodes 40, 42, 44, 46, 48, 50, 58, 62, 64, and 66, e.g., via conductors of the respective lead 18, 20, 22, or, in the case of housing electrode 58, via an electrical conductor disposed within housing 60 of IMD 16. In the illustrated example, signal generator 84 is configured to generate and deliver electrical stimulation therapy to heart 12. For example, signal generator 84 may deliver defibrillation shocks to heart 12 via at least two electrodes 58, 62, 64, 66. Signal generator 84 may deliver pacing pulses via ring electrodes 40, 44, 48 coupled to leads 18, 20, and 22, respectively, and/or helical electrodes 42, 46, and 50 of leads 18, 20, and 22, respectively. In some examples, signal generator 84 delivers pacing, cardioversion, or defibrillation stimulation in the form of electrical pulses. In other examples, signal generator may deliver one or more of these types of stimulation in the form of other signals, such as sine waves, square waves, or other substantially continuous time signals.

Signal generator 84 may include a switch module and processor 80 may use the switch module to select, e.g., via a data/address bus, which of the available electrodes are used to deliver defibrillation pulses or pacing pulses. The switch module may include a switch array, switch matrix, multiplexer, or any other type of switching device suitable to selectively couple stimulation energy to selected electrodes.

Electrical sensing module 86 monitors signals from at least one of electrodes 40, 42, 44, 46, 48, 50, 58, 62, 64 or 66 in order to monitor electrical activity of heart 12, impedance, or other electrical phenomenon. Sensing may be done to determine heart rates or heart rate variability, or to detect arrhythmias or other electrical signals. Sensing module 86 may also include a switch module to select which of the available electrodes are used to sense the heart activity, depending upon which electrode combination, or electrode vector, is used in the current sensing configuration. In some examples, processor 80 may select the electrodes that function as sense electrodes, i.e., select the sensing configuration, via the switch module within sensing module 86. Sensing module 86 may include one or more detection channels, each of which may be coupled to a selected electrode configuration for detection of cardiac signals via that electrode configuration. Some detection channels may be configured to detect cardiac events, such as P- or R-waves, and provide indications of the occurrences of such events to processor 80, e.g., as described in U.S. Pat. No. 5,117,824 to Keimel et al., which issued on Jun. 2, 1992 and is entitled, “APPARATUS FOR MONITORING ELECTRICAL PHYSIOLOGIC SIGNALS,” and is incorporated herein by reference in its entirety. Processor 80 may control the functionality of sensing module 86 by providing signals via a data/address bus.

Processor 80 may include a timing and control module, which may be embodied as hardware, firmware, software, or any combination thereof. The timing and control module may comprise a dedicated hardware circuit, such as an ASIC, separate from other processor 80 components, such as a microprocessor, or a software module executed by a component of processor 80, which may be a microprocessor or ASIC. The timing and control module may implement programmable counters. If IMD 16 is configured to generate and deliver pacing pulses to heart 12, such counters may control the basic time intervals associated with DDD, VVI, DVI, VDD, AAI, DDI, DDDR, VVIR, DVIR, VDDR, AAIR, DDIR, CRT, and other modes of pacing.

Intervals defined by the timing and control module within processor 80 may include atrial and ventricular pacing escape intervals, refractory periods during which sensed P-waves and R-waves are ineffective to restart timing of the escape intervals, and the pulse widths of the pacing pulses. As another example, the timing and control module may withhold sensing from one or more channels of sensing module 86 for a time interval during and after delivery of electrical stimulation to heart 12. The durations of these intervals may be determined by processor 80 in response to stored data in memory 82. The timing and control module of processor 80 may also determine the amplitude of the cardiac pacing pulses.

Interval counters implemented by the timing and control module of processor 80 may be reset upon sensing of R-waves and P-waves with detection channels of sensing module 86. In examples in which IMD 16 provides pacing, signal generator 84 may include pacer output circuits that are coupled, e.g., selectively by a switching module, to any combination of electrodes 40, 42, 44, 46, 48, 50, 58, 62, or 66 appropriate for delivery of a bipolar or unipolar pacing pulse to one of the chambers of heart 12. In such examples, processor 80 may reset the interval counters upon the generation of pacing pulses by signal generator 84, and thereby control the basic timing of cardiac pacing functions, including anti-tachyarrhythmia pacing.

The value of the count present in the interval counters when reset by sensed R-waves and P-waves may be used by processor 80 to measure the durations of R-R intervals, P-P intervals, P-R intervals and R-P intervals, which are measurements that may be stored in memory 82. Processor 80 may use the count in the interval counters to detect a tachyarrhythmia event, such as atrial fibrillation (AF), atrial tachycardia (AT), ventricular fibrillation (VF), or ventricular tachycardia (VT). These intervals may also be used to detect the overall heart rate, ventricular contraction rate, and heart rate variability. A portion of memory 82 may be configured as a plurality of recirculating buffers, capable of holding series of measured intervals, which may be analyzed by processor 80 in response to the occurrence of a pace or sense interrupt to determine whether the patient's heart 12 is presently exhibiting atrial or ventricular tachyarrhythmia.

In some examples, an arrhythmia detection method may include any suitable tachyarrhythmia detection algorithms. In one example, processor 80 may utilize all or a subset of the rule-based detection methods described in U.S. Pat. No. 5,545,186 to Olson et al., entitled, “PRIORITIZED RULE BASED METHOD AND APPARATUS FOR DIAGNOSIS AND TREATMENT OF ARRHYTHMIAS,” which issued on Aug. 13, 1996, or in U.S. Pat. No. 5,755,736 to Gillberg et al., entitled, “PRIORITIZED RULE BASED METHOD AND APPARATUS FOR DIAGNOSIS AND TREATMENT OF ARRHYTHMIAS,” which issued on May 26, 1998. U.S. Pat. No. 5,545,186 to Olson et al. U.S. Pat. No. 5,755,736 to Gillberg et al. is incorporated herein by reference in their entireties. However, other arrhythmia detection methodologies may also be employed by processor 80 in other examples.

In some examples, processor 80 may determine that tachyarrhythmia has occurred by identification of shortened R-R (or P-P) interval lengths. Generally, processor 80 detects tachycardia when the interval length falls below 220 milliseconds (ms) and fibrillation when the interval length falls below 180 ms. These interval lengths are merely examples, and a user may define the interval lengths as desired, which may then be stored within memory 82. This interval length may need to be detected for a certain number of consecutive cycles, for a certain percentage of cycles within a running window, or a running average for a certain number of cardiac cycles, as examples.

In the event that processor 80 detects an atrial or ventricular tachyarrhythmia based on signals from sensing module 86, and an anti-tachyarrhythmia pacing regimen is desired, timing intervals for controlling the generation of anti-tachyarrhythmia pacing therapies by signal generator 84 may be loaded by processor 80 into the timing and control module to control the operation of the escape interval counters therein and to define refractory periods during which detection of R-waves and P-waves is ineffective to restart the escape interval counters for the an anti-tachyarrhythmia pacing. In the event that processor 80 detects an atrial or ventricular tachyarrhythmia based on signals from sensing module 86, and a cardioversion or defibrillation shock is desired, processor 80 may control the amplitude, form and timing of the shock delivered by signal generator 84.

In this manner, sensing module 86 and/or processor 80 may be utilized to detect values for any type of patient parameter that may be included as at least a part of a diagnostic metric. Sending module 86 may be used to sense the appropriate electrical signals and processor 80 may analyze the electrical signals or otherwise generate parameter values to be used in one or more diagnostic metrics. This patient data generated by processor 80 may be stored in memory 82 prior to being transmitted to programmer 24 or another external device via communication module 88. In some examples, processor 80 may generate selected or desired patient data based on the diagnostic metrics to be used in generating the patient management report.

Memory 82 may be configured to store a variety of operational parameters, therapy parameters, sensed and detected data, instructions for processor 80 related to diagnostic metrics and a patient management report, and any other information related to the therapy and treatment of patient 14. In some examples, memory 82 may include separate memories to store instructions for processor to generate desired patient data, generated patient data, patient history generated by IMD 16 or received from an external device, or any other distinct types of data. Memory 82 may retain patient data once transmitted to an external device or delete patient data once the data has been transmitted.

The patient data identified and/or generated and stored by IMD 16 may include one or more of the following patient parameters. Each of these patient parameters may be used to generate a diagnostic metric that may be included in a patient management report when the value of the diagnostic metric exceeds a respective threshold. Example patient parameters that IMD 16 may detect may include oversensing episodes (e.g., electromagnetic interference, lead failure, T-wave oversensing), shock events, atrial fibrillation, ventricular tachycardia (VT), ventricular fibrillation (VF), junctional rhythms, supraventricular tachycardia (SVT) (e.g., sinus tachycardia or atrial tachycardia), monomorphic VT, anti-tachycardia pacing (ATP) events, non-sustained VT or VF events, and a mode-switch episode (e.g., changing from a tracking mode to a non-tracking mode at the onset of a pathological rhythm such as atrial fibrillation or atrial tachycardia). Other patient parameters may include any sensed or detected parameters related to cardiac rhythms, electrical or hemodynamic cardiac episodes, patient activity, patient posture, or any other physiological event or condition of the patient. These parameters may be detected or sensed via one or more electrodes or sensors in communication with IMD 16 (e.g., wired or wireless sensors).

In some examples, IMD 16 may review the detected patient parameters for accuracy, particularly with regards to detected arrhythmias. For example, IMD 16 may deliver a therapy or change monitoring parameters intended to address a detected arrhythmia (e.g., atrial fibrillation). However, IMD 16 may determine that the detected arrhythmia may have been misidentified due to an ineffective therapy or further monitoring of cardiac rhythms. An example technique for classifying events is described in U.S. Pat. No. 7,894,883 to Gunderson et al. and entitled “METHOD AND APPARATUS FOR POST-PROCESSING OF EPISODES DETECTED BY A MEDICAL DEVICE,” which issued on Feb. 22, 2011, the entirety of which is incorporated herein by referenced. In this case, IMD 16 may generate a patient parameter or other indication that an event occurred in which an arrhythmia was misidentified or inappropriately detected as a different arrhythmia. Example inappropriate detections may include an atrial fibrillation or junctional rhythm inappropriately detected as VT or VF or an SVT inappropriately detected as VT. The processing for this review of detected arrhythmias may be distributed to remote computing devices. For example, server 120 of FIG. 6 may perform this review and identify any inappropriate detections as a part of generating diagnostic metrics for a patient management report.

The patient data for diagnostic metrics may include additional patient parameters in other examples. For example, the patient parameters may also include a thoracic fluid index (or a thoracic impedance), an atrial tachycardia or fibrillation burden, a ventricular contraction rate during atrial fibrillation, a patient activity, a nighttime heart rate, a difference between night and day heart rate, a heart rate variability, a cardiac resynchronization therapy percentage, a bradyarrhythmia pacing therapy percentage (in a ventricle and/or atrium), and number or frequency of electrical shock events. In other examples, other patient parameters may be stored that may be useful in a patient management report, e.g., blood pressure, right ventricular pressure, pulmonary artery pressure, stroke volume, left ventricular ejection fraction, patient temperature, maximum heart rate (in combination with activity level), lung volume, lung tidal volume, lung density, breathing rate or even biomarkers such as a brain natriuretic peptide (BNP), troponin, or related surrogates. In such examples, IMD 16 may include or be coupled to sensors known in the art for detecting such parameters. In some examples, the atrial tachycardia or fibrillation burden may be a time of the event, a percent or amount of time over a certain period, a number of episodes, or even a frequency of episodes. IMD 16 may transmit one or more of these patient parameters to a computing device that may generate a diagnostic metric based on one or more of the patient parameters.

The cardiac resynchronization therapy (CRT) parameter may be the amount or percentage of time each day, or an amount of percentage of cardiac cycles, as examples, that IMD 16 delivers cardiac resynchronization therapy to heart 12. Low CRT amounts or percentages may indicate that beneficial therapy is not being delivered and that adjustment of therapy parameters, e.g., an atrioventricular delay or a lower pacing rate, may improve therapy efficacy. In one example, higher CRT amounts or percentages may indicate that heart 12 is sufficiently pumping blood through the vasculature with the aid of therapy to prevent fluid buildup. In examples of other types of cardiac pacing (non-CRT) or stimulation therapy, higher therapy percentages may indicate that heart 12 is unable to keep up with blood flow requirements.

In this manner, processor 80 may automatically detect each of the patient parameters and store them (e.g., store values of the patient parameters) within memory 82 for later transmission. Processor 80 may control communication module 88 to transmit some or all of the patient parameters stored in memory 82 when requested by another device, whenever a communication link is established between IMD 16 and another device, or during a scheduled transmission period (e.g., hourly, daily, or weekly). Memory 82 may delete or continue to store patient parameters after the parameters are transmitted. Alternatively, processor 80 may continue to store patient parameters until memory 82 is full. Upon which processor 80 may delete the oldest data as necessary to store newly collected patient data (e.g., values of the patient parameters).

In other examples, IMD 16 may include an activity sensor (e.g., sensor 92) that may include one or more accelerometers or other devices capable of detecting motion and/or position of patient 14. The activity sensor may therefore detect activities of patient 14 or postures engaged by patient 14. The output from the activity sensor may be used by processor 80 to monitor the patient activity and produce one or more patient parameter. The patient parameter may be based on the magnitude or duration of the output from the activity sensor representative of a specific activity, posture, or other patient situation.

Sensor 92 may include one or more additional sensors housed within IMD 16. This sensor may be one or more accelerometers, gyroscopes, temperature sensors, impedance sensors, optical sensors, pressure sensors, acoustic sensors, or any other sensors configured to generate a signal representative of a physiological or anatomical event of patient 14. In this manner, sensor 92 may be configured to obtain activity, heart sound, pressure, or any other information about patient 14. In addition, or alternatively, sensor 94 may be in communication with IMD 16 via lead 96. Sensor 94 may be similar to sensor 92 and detect one or more physiological events of conditions of patient 14. In other examples, sensor 94 may be a wireless capsule that communicates wirelessly with IMD 16 via communication module 88 instead of lead 96. One or more diagnostic metrics may include values from one or both of sensors 94 and 94.

Communication module 88 may include any suitable hardware, firmware, software or any combination thereof for communicating with another device, such as programmer 24 (FIG. 1). Under the control of processor 80, communication module 88 may receive downlink telemetry from and send uplink telemetry to programmer 24 with the aid of an antenna, which may be internal and/or external. Processor 80 may provide the data to be uplinked to programmer 24 and the control signals for the telemetry circuit within communication module 88, e.g., via an address/data bus. In some examples, communication module 88 may provide received data to processor 80 via a multiplexer. Communication module 88 may transmit and/or receive data via radio frequency communication, inductance coupling, tissue conductance communication, or any other communication protocol for transmitting data to programmer 24, wireless sensor 94, or another device.

In some examples, processor 80 may transmit atrial and ventricular heart signals, e.g., EGMs, produced by atrial and ventricular sense amplifier circuits within sensing module 86 to programmer 24. Programmer 24 may interrogate IMD 16 to receive the heart signals. Processor 80 may store heart signals within memory 82, and retrieve stored heart signals from memory 82. Processor 80 may also generate and store marker codes indicative of different cardiac events that sensing module 86 detects, and transmit the marker codes to programmer 24. An example pacemaker with marker-channel capability is described in U.S. Pat. No. 4,374,382 to Markowitz, entitled, “MARKER CHANNEL TELEMETRY SYSTEM FOR A MEDICAL DEVICE,” which issued on Feb. 15, 1983 and is incorporated herein by reference in its entirety.

In some examples, IMD 16 may signal programmer 24 to further communicate with and pass the alert through a network such as the Medtronic CareLink® Network developed by Medtronic, Inc., of Minneapolis, Minn., or some other network linking patient 14 to a clinician. In this manner, a computing device or user interface of the network may be the external computing device that delivers diagnostic metrics to a clinician individually or as part of a patient management report that includes at least one diagnostic metric from one or more patients. IMD 16 may spontaneously transmit the patient data to the network or in response to an interrogation request from a user. Generally, an external computing device may generate the diagnostic metrics and the patient management report. In other examples, one or more steps in the generation of diagnostic metrics and/or the patient management report may be performed by processor 80 within IMD 16.

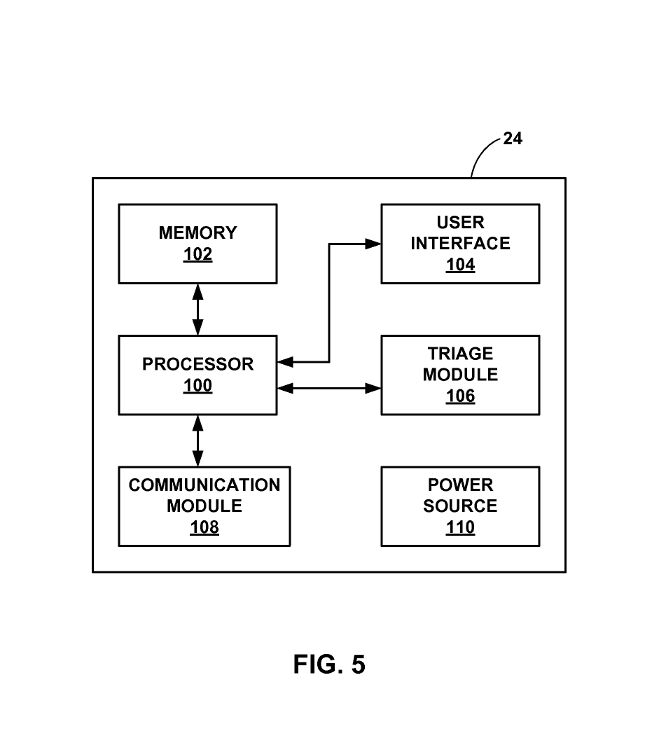

FIG. 5 is a functional block diagram illustrating an example configuration of external programmer 24. As shown in FIG. 5, programmer 24 may include a processor 100, memory 102, user interface 104, triage module 106, communication module 108, and power source 110. Programmer 24 may be a dedicated hardware device with dedicated software for programming of IMD 16. Alternatively, programmer 24 may be an off-the-shelf computing device running an application that enables programmer 24 to program IMD 16.

A user may use programmer 24 to configure the operational parameters of and retrieve data from IMD 16 (FIG. 1). The clinician may interact with programmer 24 via user interface 104, which may include display to present graphical user interface to a user, and a keypad or another mechanism for receiving input from a user. In addition, the user may receive an alert or notification from IMD 16 indicating that patient 14 needs attention. Alternatively, programmer 24 may generate a diagnostic metric and/or a patient management report regarding any physiological issues related to patient 14 and/or additional patients.

Processor 100 can take the form one or more microprocessors, DSPs, ASICs, FPGAs, programmable logic circuitry, or the like, and the functions attributed to processor 100 herein may be embodied as hardware, firmware, software or any combination thereof. Memory 102 may store instructions that cause processor 100 to provide the functionality ascribed to programmer 24 herein, and information used by processor 100 to provide the functionality ascribed to programmer 24 herein. Memory 102 may include any fixed or removable magnetic, optical, or electrical media, such as RAM, ROM, CD-ROM, hard or floppy magnetic disks, EEPROM, or the like. Memory 102 may also include a removable memory portion that may be used to provide memory updates or increases in memory capacities. A removable memory may also allow patient data to be easily transferred to another computing device, or to be removed before programmer 24 is used to program therapy for another patient.

Programmer 24 may communicate wirelessly with IMD 16, such as using RF communication or proximal inductive interaction. This wireless communication is possible through the use of communication module 108, which may be coupled to an internal antenna or an external antenna. An external antenna that is coupled to programmer 24 may correspond to the programming head that may be placed over heart 12, as described above with reference to FIG. 1. Communication module 108 may be similar to communication module 88 of IMD 16 (FIG. 5).

Communication module 108 may also be configured to communicate with another computing device via wireless communication techniques, or direct communication through a wired connection. Examples of local wireless communication techniques that may be employed to facilitate communication between programmer 24 and another computing device include RF communication according to the 802.11 or Bluetooth specification sets, infrared communication, e.g., according to the IrDA standard, or other standard or proprietary telemetry protocols. In this manner, other external devices may be capable of communicating with programmer 24 without needing to establish a secure wireless connection. In other examples, communication module 108 may utilize tissue conductance communication or other communication techniques. An additional computing device in communication with programmer 24 may be a networked device such as a server capable of processing information retrieved from IMD 16. In this manner, a server may include a triage module similar to triage module 106 of programmer 24.

In some examples, programmer 24 may transmit patient data from IMD 16 and/or other patient information to a remote server (e.g., remote server 120 of FIGS. 3 and 6). Remote server 120 may then generate diagnostic metrics, compare diagnostic metrics to respective thresholds, and generate patient management reports for one or more clinicians. Programmer 24 may transmit the patient data to the remote server in response to obtaining new patient data, according to a predetermined schedule, or upon a request from the remote server or other remote computing device. In some examples, programmer 24 may perform some analysis on the patient data and/or patient information necessary to generate diagnostic metrics and/or the patient management reports. In this manner, some processing involved with generating diagnostic metrics and/or the patient management report may be distributed to programmer 24 prior to or subsequent to transmitting the patient data or patient information to the remote server.

In some examples, user interface 104 may present a patient management report to the user. The patient management report may include diagnostic metrics for one or more patients, and programmer 24 may be within the vicinity of one of the patients or remote from all patients represented in the patient management report. Programmer 24 may receive the patient management report from a remote server via a network (e.g., remote server 120 and network 144 of FIG. 3) and communication module 108. In other examples, programmer 24 may generate the patient management report from diagnostic metrics generated by triage module 106 of programmer 24 and/or received from remote server 120. If the patient management report includes one or more diagnostic metrics that indicate one or more therapy parameters should be changed for a patient, the user may modify the one or more therapy parameters of IMD 16, for example, using programmer 24. In some examples, the patient management report may include a suggested change or parameter value for the therapy parameters that should be changed (e.g., the suggested parameter change may be the fibrillation detection interval from 300 ms to 340 ms). For example, Triage module 106 or 130 of server 120 may utilize an algorithm to determine the value of the suggested parameter change.

User interface 104 may also be configured to receive clinician input that customizes one or more aspects of the diagnostic metrics and/or patient management report. For example, user interface 104 may receive clinician input selecting at least one reporting characteristic for each of a plurality of diagnostic metrics. Triage module 106 may then organize the diagnostic metrics for the patient management report based on the selected reporting characteristic. In other examples, programmer 24 may transmit any received clinician input selecting one or more reporting characteristics to remote server 120 or any other computing device that may include a triage module configured to generate the patient management report.

User interface 104 may receive clinician input or customization requests related to diagnostic metrics or patient management reports at any time. For example, the clinician may be using programmer 24 to review patient data, update a therapy parameter, or otherwise monitor or diagnose patient 14. Based on the reviewed patient data, a discussion with patient 14, and/or a discussion with another healthcare professional, the clinician may desire to change the customization of the periodically-received patient management report. In this manner, the clinician may update patient management report organizational preferences or content preferences at any time. In response to receiving the clinician input representative of the updated clinician preferences for the patient management report, programmer 24 may store the clinician input and/or transmit the input to a remote server or other computing device that generates the patient management report.

Programmer 24 may also include triage module 106. Triage module 106 may provide some or all functionality required for generating diagnostic metrics, comparing diagnostic metrics to respective thresholds, and/or generating patient management reports. In this manner, triage module 106 may include some or all of the functionality described with respect to triage module 130 of remote server 120 in FIG. 6. In other examples, triage module 106 may assist in obtaining patient data from IMD 16 and/or clinician input for patient management report preferences.

Triage module 106 may also manage patient information stored in memory 102 that may be used as a part of the diagnostic metrics. For example, triage module 106 may manage information or notes about patient 14 entered by a clinician, or other history information. In this manner, triage module 106 may collect patient data and/or information from one or more devices before transmitting the information to a remote server or computing device that generates the patient management report. Triage module 106 may act as an intermediary between IMD 16 and a remote computing device in some examples.

In some examples, processor 100 of programmer 24 and/or one or more processors of one or more networked computers may perform all or a portion of the techniques described herein with respect to processor 80, processor 100, triage module 106, processors 122 (of FIG. 6), or triage module 130 (of FIG. 6). For example, processor 100 or triage module 106 within programmer 24 may analyze raw patient data to generate diagnostic metrics and/or compare the diagnostic metrics to respective thresholds.

FIG. 6 is a functional block diagram illustrating an example configuration of remote server 120 configured to generate a patient management report. FIG. 6 illustrates only one particular example of server 120, and many other example embodiments of server 120 may be used in other instances. For example, server 120 may include additional components and run multiple different applications.

As shown in the specific example of FIG. 6, sever 120 may include and/or house one or more processors 122, memory 124, a network interface 126, user interface 128, triage module 130, and power source 132. Server 120 may be in communication with repository 134, such that repository 134 is located external of server 120. In other examples, repository 134 may include one or more storage devices within an enclosure of server 120. Server 120 may also include an operating system, which may include modules and/or applications that are executable by processors 122 and server 120. Each of components 122, 124, 126, 128, 130, 132, and 134 may be interconnected (physically, communicatively, and/or operatively) for inter-component communications.

Processors 122, in one example, are configured to implement functionality and/or process instructions for execution within server 120, such as generating diagnostic metrics and patient management reports. For example, processors 122 may be capable of processing instructions stored in memory 124 or instructions stored in repository 134. These instructions may define or otherwise control the operation of server 120.

Memory 124, in one example, is configured to store information within server 120 during operation. Memory 124, in some examples, is described as a computer-readable storage medium. In some examples, memory 124 is a temporary memory, meaning that a primary purpose of memory 124 is not long-term storage. However, memory 124 may also be described as non-transitory. Memory 124, in some examples, may be described as a volatile memory, meaning that memory 124 does not maintain stored contents when the computer is turned off. Examples of volatile memories include random access memories (RAM), dynamic random access memories (DRAM), static random access memories (SRAM), and other forms of volatile memories known in the art. In some examples, memory 124 is used to store program instructions for execution by processors 122. Memory 124, in one example, is used by software or applications running on server 120 to temporarily store information during program execution.

Repository 134, in some examples, also includes one or more computer-readable storage media. Repository 134 may be configured to store larger amounts of information than memory 124. Repository 134 may further be configured for long-term storage of information. In some examples, repository 134 may include non-volatile storage elements. Examples of such non-volatile storage elements include magnetic hard discs, optical discs, floppy discs, flash memories, or forms of electrically programmable memories (EPROM) or electrically erasable and programmable (EEPROM) memories. Repository 134 may be configured to store patient information and/or patient data used to generate diagnostic metrics and patient management reports. For example, repository 134 may store patient history 136 and IMD data 138. Patient history 136 may include any history, information, observations, or any other data related to the monitoring, diagnosis and/or treatment of one or more patients. IMD data 138 may include sensed or detected patient data obtained from one or more implantable medical device such as IMD 16. IMD data 138 may include data from one or more patients. For each of patient history 136 and IMD data 138, repository 134 may maintain separate files for each patient or otherwise maintain security of the data to retain patient privacy.

Server 120, in some examples, also includes a network interface 126. Server 120, in one example, utilizes network interface 126 to communicate with other computing devices, programmers (e.g., programmer 24), medical devices (e.g., IMD 16), or more networks, such as network 144 in FIG. 3. Network interface 126 may be a network interface card, such as an Ethernet card or other wired interface. In other examples, network interface 126 may include an optical transceiver, a radio frequency transceiver, or any other type of device that can send and receive information. Other examples of such network interfaces may include Bluetooth, 3G and WiFi radios in mobile computing devices as well as USB. In some examples, server 120 utilizes network interface 126 to wirelessly communicate with another computing device (e.g., computing device 146N of FIG. 3) or other networked computing device.

Server 120, in one example, also includes one or more user interfaces 48. User interface 128 may include a touch-sensitive and/or a presence-sensitive screen, mouse, a keyboard, a voice responsive system, camera, or any other type of device for detecting a command from a user. In one example, user interface 128 may include a touch-sensitive screen, sound card, a video graphics adapter card, or any other type of device for converting a signal into an appropriate form understandable to humans or machines. In addition, user interface 128 may include a speaker, a cathode ray tube (CRT) monitor, a liquid crystal display (LCD), or any other type of device that can generate intelligible output to a user.

Server 120, in some examples, includes one or more power sources 132, which provide power to server 120. Generally, power source 132 may utilize power obtained from a wall receptacle or other alternating current source. However, in other examples, power source 132, may include one or more rechargeable or non-rechargeable batteries (e.g., constructed from nickel-cadmium, lithium-ion, or other suitable material). In other examples, power source 132 may be a power source capable of providing stored power or voltage from another power source.

As described herein, a patient management report may be generated with diagnostic metrics from one or more patients and organized based on preferences provided by one or more clinicians. In this manner, a clinician may receive a generated patient management report that is customized to the specific interests and/or preferences of the clinician. This customization may benefit clinicians with different numbers of patients to manage, different types of patients, different clinic environments, or any other aspect of the clinician practice that may vary from one clinician to another clinician. Generally, the patient management report may be generated by one or more servers 120 that are in communication with IMDs, patient programmers, clinician programmers, and/or other computing devices. However, in some examples, one or more aspects of generating the patient management report may be performed by a different device, such as programmer 24 or another external computing device.

In one example, server 120 may receive a clinician input selecting at least one reporting characteristic for each of a plurality of diagnostic metrics and organize the diagnostic metrics based on the selected reporting characteristic. Server 120 may also receive patient data for at least one patient, determine a value for at least a subset of the diagnostic metrics based on the patient data, and generate a patient management report comprising the diagnostic metrics having a value that exceeds a respective threshold, wherein the diagnostic metrics are ordered in the patient management report based on the organization. The order or rank of the diagnostic metrics may be determined by the organization of the reporting characteristics based on the clinician preferences. Server 120 may then transmit the patient management report to programmer 24 or another computing device for review by a clinician.

Server 120 may receive the clinician input in the form of a signal representative of an input received by programmer 24 or another computing device (e.g., a tablet computing device or a personal computer used by the clinician). In other words, another computing device (e.g., programmer 24) may transmit a signal representative of the clinician input to server 120. In other examples, server 120 may receive the clinician input directly via user interface 128.

The clinician input may select at least one reporting characteristic for at least one a plurality of diagnostic metrics. Each diagnostic metric may have one or more reporting characteristic that can be used by server 120 to organize the diagnostic metrics within the patient management report. For example, the diagnostic metrics may be grouped together such that the diagnostic metrics with similar or same reporting characteristics will show up together within the patient management report. In another example, the reporting characteristic may be used to rank or order each diagnostic metric within the patient management report. In this manner, patients may be triaged such that patients with more urgent diagnostic metrics may appear higher on the patient management report than patients with less urgent diagnostic metrics. Since the patient management report may be sorted by diagnostic metrics, the more urgent diagnostic metric may appear higher for a patient even if the patient also has a lesser urgent diagnostic metric in the report as well.

The patient management report may include multiple reporting characteristics for each diagnostic metric such that each reporting characteristic may be selected to organize the diagnostic metrics within the patient management report. In other words, selection of one reporting characteristic may cause server 120 to sort the diagnostic metrics according to the selected reporting characteristic. Organizing the diagnostic metrics may thus include ranking or grouping the diagnostic metrics based on the selected reporting characteristic for each of the diagnostic metrics. The diagnostic metrics may be ordered in the patient management report based on the organization specified by the selected reporting characteristic and/or additional information.

Example reporting characteristics may include an urgency score, a treatment action, or a treatment time. For each diagnostic metric, a value or type of the reporting characteristic may be assigned and used to sort the diagnostic metrics. For example, each diagnostic metric may have an urgency score assigned between 1 and 5, where 5 is more urgent than a 1. Types of treatment actions may include changing therapy parameters, changing medications and/or dosages, change monitoring frequency, provide surgical interventions (e.g. ablation), or perhaps no treatment. In other examples, a treatment action may be to call or otherwise check-in with the patient. The treatment times may be how quickly the patient should be seen by a clinician and/or the treatment action should occur. Example treatment times may be selected to be between one or more hours to several weeks or even months.

The clinician input that selects the reporting characteristic may provide at least one preference for the patient management report. In other words, the reporting characteristic may be one way in which the clinician may customize the patient management report according to the preferences of the clinician. The preference may indicate how the clinician desires to triage patients by their diagnostic metrics. For example, the clinician may desire to group the diagnostic metrics (essentially grouping the patients) by what treatment may be needed. The preference may instead group the diagnostic metrics by the available time for treatment or rank the diagnostic metrics by urgency.

Server 120 may receive additional or alternative input providing other preferences. For example, server 120 may, in response to input received from the clinician, show only diagnostic metrics not previously presented in a patient management report. Since the clinician may know that a particular patient is always in a state of atrial fibrillation or some other condition represented by a diagnostic metric, the clinician may not want that patient's continual condition (and other continual conditions of other patients) burying diagnostic metrics new to the patient management report. In other examples, the patient management report may organize the diagnostic metrics by a reporting characteristic of how many times each diagnostic metric has been above threshold and/or the amount of time each diagnostic metric has been included in the patient management report. In other words, the patient management report may be organized into information the clinician already knows (e.g., previously presented diagnostic metrics) and information the clinician does not already know (e.g., diagnostic metrics new to the patient management report).

In some examples, the clinician may provide input selecting a reporting characteristic whenever the clinician desires. In other examples, server 120 may generate and deliver a clinician survey to the clinician such that the clinician input is received via the clinician survey. Server 120 may present the clinician survey to the clinician or server 120 may transmit the clinician survey to programmer 24 or another computing device such that the clinician may view the survey and provide input selecting one or more reporting characteristics, identifying the appropriate reporting characteristics for each possible diagnostic metric (e.g., the value or subtype of each reporting characteristic) or any other preferences related to the patient management report. The clinician survey may form the basis for how the patient management report is generated. Server 120 may present the clinician survey once, periodically, upon the addition of new diagnostic metrics, or in response to a request from the clinician or clinic administration.

In other examples, the server 120 may receive clinician input from multiple different clinicians to determine how to generate the patient management report. For example, server 120 may receive, from a plurality of different clinicians, input selecting at least one reporting characteristic for each of the plurality of diagnostic metrics. In other words, each clinician may provide their desired reporting characteristic for each diagnostic metric. Server 120 (e.g., triage module 130) may then generate at least one composite reporting characteristic for each of the plurality of diagnostic metrics based on the selected reporting characteristics from the plurality of clinicians. The composite reporting characteristic may be an average or compilation (e.g., the most common selection) of all of the clinician inputs. For example, the urgency score for each diagnostic metric may be the average of the integer score from each input. Triage module 130 may organize the diagnostic metrics based on the at least one composite reporting characteristic. In some examples, each clinician may request that the patient management report may be organized according to their individual reporting characteristic selections or the composite reporting characteristics from multiple clinicians. The multiple clinicians may be from the same clinic, from the same geographical area, a specific healthcare organization, or all clinicians using the patient management report across one or more countries.

In order to generate the patient management report, triage module 130 may receive patient data for at least one patient. The patient data may include sensed or detected parameters from IMD 16 for each patient, patient history information, or any other information that may be used to generate each of the diagnostic metrics. The patient data may be received from one source (e.g., IMD 16) or multiple sources (e.g., IMD 16, programmer 24, repository 134, and/or any other local or remote database of the patients). Programmer 24 may be a clinician or a patient programmer. Server 120 may store any received patient data as patient history 136 and/or IMD data 138 within repository 134. Triage module 130 may then retrieve the patient data as needed from repository 134.

Triage module 130 may also determine a value for at least a subset of the diagnostic metrics based on the received patient data from one or more sources. The value of each diagnostic metric may be determined by analyzing one or more pieces of received patient data. In other examples, the value of one or more diagnostic metrics may have been determined by another device, such as IMD 16 and/or programmer 24. Triage module 130 may then compare the diagnostic metric values to one or more respective thresholds of each diagnostic metric. If the diagnostic metric value exceeds its threshold, the diagnostic metric may be included in the patient management report. In other words, only diagnostic metrics exceeding a threshold may indicate that the patient requires attention from the clinician or other healthcare professional. Triage module 130 may thus generate the patient management report that includes the diagnostic metrics having a value that exceeds the respective threshold. Some patients may have multiple diagnostic metrics included in the patient management report. Other patients may not have any diagnostic metrics included. In this fashion, the patient management report may only indicate those patients requiring attention.

Once triage module 130 generates the patient management report, server 120 may transmit the patient management report for viewing by a clinician. Network interface 126 may be configured to transmit the patient management report to a computing device (e.g., programmer 24 or computing device 146N of FIG. 3). In some examples, the computing may be associated within the system that includes server 120. The computing device may also be configured to receive the patient management report and present the patient management report to a clinician. The computing device may present the patient management report via a user interface. In some examples, the patient management report may be interactive such that the diagnostic metrics may be sortable according to different reporting characteristics. In other examples, the patient management report may be static and any changes may result in generating and transmission of a new patient management report. In some examples, the patient management report may be transmitted to a computing device that is or includes a printer. The printer may print out a copy of the patient management report for the clinician.

The diagnostic metrics may be generated using a sensed component (e.g., a value from IMD 16 or another medical device) and/or a patient information component entered by a clinician. In this manner, at least one diagnostic metric may provide a synthesis of sensed data and characteristics of the patient to synthesize useful information about any changes to the patient condition and/or treatment. One or more diagnostic metrics may thus provide additional information than would otherwise be available from only IMD 16 or only clinician notes. For example, patient history 136 may include clinician entered information and/or observations about the patient not sensed or detected by a medical device. IMD data 138 may include patient data sensed or detected from one or more sensors. The synthesis of this information obtained about each patient may help the clinician or other healthcare practitioner to more effectively treat patients within the clinic and particularly those patients remote from the clinic setting.

In one example, the diagnostic metrics that may be provided in a patient management report may include at least two of a number of monomorphic ventricular tachycardia episodes with similar morphology, a first ventricular tachycardia or ventricular fibrillation in a primary prevention patient, a ventricular tachycardia episode caused by anti-tachycardia induced acceleration, an increase in frequency of cardiac episodes, a first non-sustained ventricular tachycardia in the primary prevention patient, and an implantable medical device delivered shock. Other diagnostic metrics may also be included. A primary prevention patient may be a patient that is healthy but may be at risk for one or more conditions. By incorporating such information about the patient's treatment status, the detected data may be more effectively used to quickly treat the patient.

Each of the diagnostic metrics may have a respective threshold or thresholds that indicate when to include the diagnostic metric in the patient management report. In other words, the threshold may indicate when the diagnostic metric indicates a change or a problem with the patient that may need to be addressed. Example thresholds may include at least two of six monomorphic ventricular tachycardia episodes with similar morphology, one ventricular tachycardia or ventricular fibrillation in a primary prevention patient, one ventricular tachycardia episode caused by anti-tachycardia induced acceleration, an increase in frequency of cardiac episodes (e.g., approximately a 10 percent increase or generally a threshold of approximately 5 to approximately 50 percent increase in frequency of cardiac episodes), one non-sustained ventricular tachycardia in the primary prevention patient, and one implantable medical device delivered shock. These thresholds may be predetermined and accessible by triage module 130 or customizable by the clinician.

Triage module 130 may be configured to perform all or some of the functions described here related to organizing diagnostic metrics, generating diagnostic metrics, comparing diagnostic metrics to respective thresholds, and generating the patient management report. However, processors 122 may assist triage module 130 or perform one or more functions in other examples. In some examples, triage module 130 may be provided as hardware, firmware, or software. In other examples, triage module 130 may be provided as some combination of hardware, firmware, and/or software. Server 120 may utilize additional software applications and/or hardware modules to manage any functionality described herein with respect to server 120. Any software implemented within or executed by server 120 may be implemented or contained within, operable by, executed by, and/or be operatively/communicatively coupled to components of server 120 (e.g., processors 122, memory 124, network interface 126, and/or repository 134).

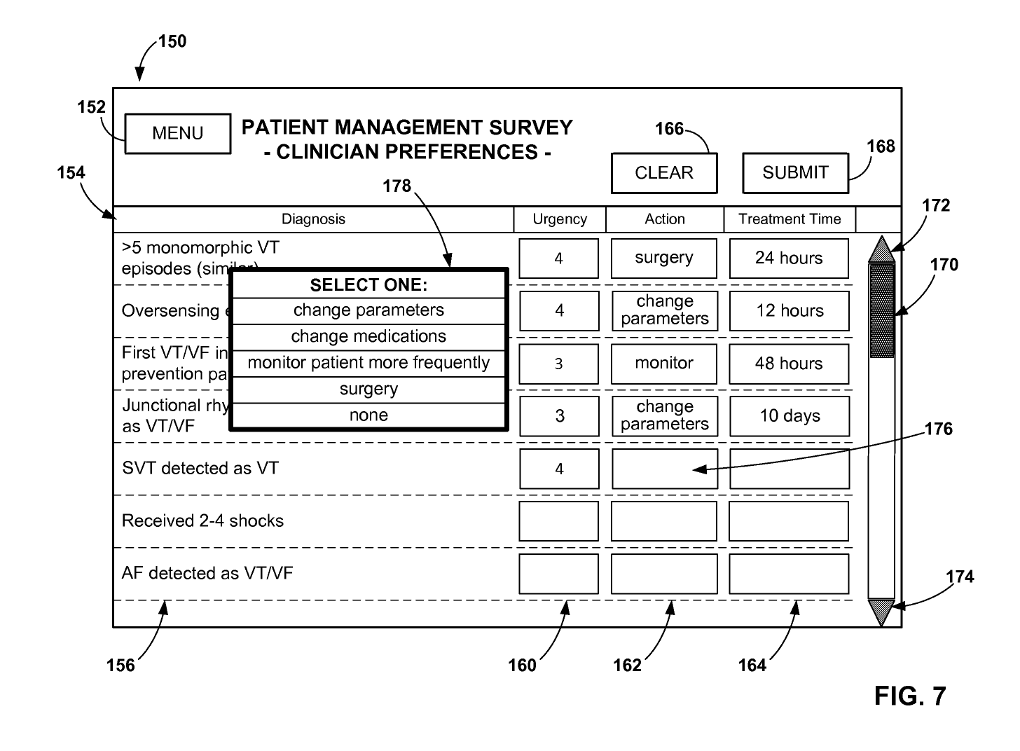

FIG. 7 illustrates example screen 150 presented by a user interface that includes a clinician survey for receiving clinician input related to diagnostic metrics. Although screen 150 is described as being presented on user interface 104 of programmer 24, screen 150 may be presented on any user interface of any device used by a healthcare professional (e.g., computing devices 146 or user interface 128 of server 120). The clinician survey of screen 150 may be transmitted to a user initially when setting up the preferences for future patient management reports, if new diagnostic metrics become available, if any changes to the patient management report occur, or at some interval (e.g., every 6 months or a year) so that the clinician is prompted to update the preferences for each diagnostic metric and selected reporting characteristics. Alternatively, the clinician may request the clinician survey of screen 150 to update one or more preferences.

As shown in FIG. 7, screen 150 includes menu 152, headings 154, diagnostic metrics 156, urgency scores 160, treatment actions 162, treatment times 164, clear button 166, and submit button 168. Screen 150 also includes scroll bar 170 and arrow 172 and 174. Window 178 is provided as a pop-up window when input area 176 is selected. Screen 150 is generally interactive such that the user interface 104 presenting screen 150 may receive clinician input into one or more areas of screen 150. In some examples, user interface 104 may be a touchscreen. In other examples, user interface 104 may receive input via a mouse or other pointing device and a keyboard for entering text and/or numerals. In other examples, screen 150 may not be interactive. Instead, the clinician may need to move to different screens in order to add or change values of the reporting characteristics shown in the clinician survey of screen 150. Although screen 150 provides multiple different types of information on one screen (e.g., diagnostic metrics and reporting characteristics, the information of screen 150 may be split into multiple different screens in other examples.

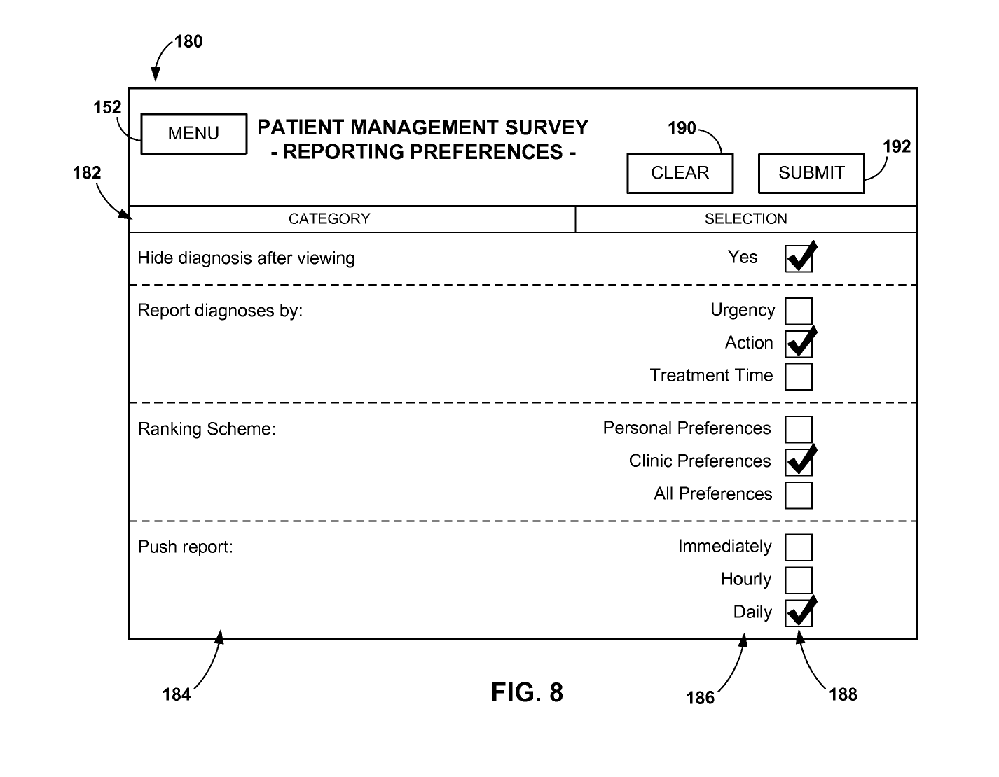

Menu 152 may allow the clinician to view other information related to generating a patient management report. For example, when selected, menu 152 may cause processor 100 to present a list of other options for the clinician to view such as additional reporting preferences (e.g., screen 180 of FIG. 8), diagnostic metric details and/or thresholds, past patient management reports, sources of the patient data used for diagnostic metrics, or any other information available to the clinician. Menu 152 may also present other functionalities provided by programmer 24 related to monitoring and/or treating a patient with IMD 16, for example.

In the clinician survey presented in screen 150, the clinician may be able to provide clinician input that sets the value of each reporting characteristic (e.g., urgency scores 160, treatment actions 162, and treatment times 164) for each possible diagnostic metric 156. The reporting characteristics may then be used to group, rank, or otherwise organize the diagnostic metrics for patients when they are deemed to be included within the patient management report (e.g., when a diagnostic metric exceeds a respective threshold). In this manner, the clinician survey of screen 150 may collect clinician preferences as to which diagnostic metrics are urgent, which metrics require certain courses of treatment, a timeframe for addressing a metric that exceeds a threshold, or any other reporting characteristic that may allow server 120 or another device to organize the diagnostic metrics for presentation in the patient management report.

Headings 154 may include “Diagnosis” (e.g., the diagnostic metrics), “Urgency,” “Action,” and “Treatment Time.” Each of diagnostic metrics 156 that may be provided in a patient management report may be provided in the column under “Diagnosis” of headings 154. Diagnostic metrics 156 are shown as incorporating each respective threshold (e.g., the patient “Received 2-4 shocks”). In other examples, diagnostic metrics 156 may be provided in screen 150 without reference to their respective threshold necessary to be included in the patient management report (e.g., “Received 2-4 shocks” may be displayed as “Shocks received” or some other indication that does not incorporate a threshold).

As shown in FIG. 7, not all of the diagnostic metrics may fit within screen 150 at one time. Scroll bar 170 and/or arrows 172 may allow the user to scroll up or down the list of diagnostic metrics 156 to view other diagnostic metrics 156 now within the viewable field of the survey. If user interface 104 is a touchscreen, the user may touch the surface of the touchscreen and move a finger up or down to scroll within the diagnostic metrics. In other examples, screen 150 may allow the clinician to scroll horizontally to view additional information to the left or right of the items shown in screen 150. Screen 150 may provide other control mechanisms to allow the clinician to adjust other viewable options for the clinician survey of screen 150.

Each diagnostic metric 156 may be associated with three different reporting characteristics. Each of urgency scores 160, treatment actions 162, and treatment times 164 are reporting characteristics that may be used to organize (e.g., sort, rank, or group) diagnostic metrics 156. As described herein, the clinician may customize the patient management report by selecting one of the reporting characteristics to organize diagnostic metrics 156 that are exceeding their respective thresholds. In other words, the patient management report may present diagnostic metrics, for a given patient, in a manner that may help the clinician effectively treat those patients that have one or more diagnostic metrics above threshold. In screen 150, the clinician may specify a value for each of the reporting characteristics of each diagnostic metric 156 such that the diagnostic metrics may be organized in a future patient management report. In some examples, default values for each of the reporting characteristics may be provided based on general experience, other clinician selections, or some other information source. In this manner, the clinician may only modify one or more values if desired. For example, the default values may be the most frequent value entered by other clinicians. In one example, the default value may be a “5” with a notation of the percentage of users that selected that value (e.g., “78% of users selected an urgency score of “5”).

Urgency scores 160 indicate the urgency of the identified diagnostic metric 156 that has exceeded the respective threshold. In the example of FIG. 7, urgency scores 160 may be based on a scale from 1 to 5, with 5 being the most urgent condition for a patient. In other words, a diagnostic metric with an urgency score of 5 may indicate a life threatening situation whereas a diagnostic metric with an urgency score of 1 may indicate a minor issue that may or may not interrupt a patient's day-to-day activities. Although the values of urgency scores 160 may be integers, screen 150 may accept factional numbers in some examples. In other examples, urgency scores 160 may be set on a different scale (e.g., 1 to 10) according to an alphabetical scale (e.g., A to F), or a color-coded triage scale (e.g., black, red, yellow, and green).

Therapy actions 164 may indicate the type of action that may be performed by the clinician in response to the respective diagnostic metric 156 exceeding the threshold and being presented in the patient management report. For example, the clinician may want to change one or more therapy parameters that defines the therapy delivered by a medical device (e.g., IMD 16), change a medication prescription (e.g., oral, intravascular, or device delivered medications), monitor the patient more frequently (e.g., change a nurse schedule and/or increase device monitoring instructions from IMD 16), perform one or more surgical procedures, or perhaps even take no action whatsoever. Each of these different values for therapy actions 164 may allow the diagnostic metrics 156 to be grouped metrics having like actions. For example, a clinician may have time to change any therapy parameters for patients needing such an action. The clinician may then group diagnostic metrics 156 together so that the clinician can see quickly identify those patients needing a change in therapy parameters.

Treatment times 164 may indicate the time in which the patient's diagnosis should be addressed. Typically, diagnostic metrics 156 with higher urgency scores may also have shorter treatment times 164. However, that relationship may not always be accurate. The clinician may enter the amount of time in which the diagnostic metric indicated in the patient management report should be addressed. For example, the clinician may enter 1 hour, 24 hours, 7 days, or any other appropriate time. In some examples, the clinician may enter a range of treatment times for one or more diagnostic metric 156. Additional reporting characteristics may be provided in other examples (e.g., next patient scheduled appointment, first time diagnostic metric has exceeded the threshold, or any other characteristic). In some examples, screen 150 may allow the clinician to create new reporting characteristics for customizing the patient management report.

For any of the reporting characteristics, the clinician may select the box of a particular reporting characteristic for a specific diagnostic metric 156. Upon this selection, the clinician may enter the value into the box or be directed to a pop-up window or other screen where the value may be entered and received by the system. For example, user interface 104 may present pop-up window 178 when box 176 is selected for therapy actions 162. Pop-up window 178 may include possible values that the clinician may select for the specific therapy action and diagnostic metric. Once user interface 104 receives the selection from pop-up window 178, the selection may be entered as the value for therapy action 162 within box 176. Instead of provided selections, pop-up window 178 may be a text field into which the clinician may enter the value of the reporting characteristic for the specific diagnostic metric 156.

Once the clinician has finished entering values for each of the reporting characteristics and diagnostic metrics 156, the clinician may select submit button 168 to store the values of the reporting characteristics for future patient management reports. If the clinician has not entered values for all reporting characteristics, programmer 24 may store the values that were entered and leave the remainder of values undefined. If any values are left undefined, user interface 104 may present a warning to the clinician that more values are to be entered and require acknowledgement before leaving screen 150. Selection of clear button 166 may clear all entries for the reporting characteristic values.

In some examples, a user may enter multiple values for a reporting characteristic. For example, the clinician survey may accept multiple actions for therapy actions 162 (e.g., both change parameters and change medications) for each diagnostic metric 156. When multiple values are selected, the respective diagnostic metric 156 may then be ordered within each group of the values selected for the reporting characteristic. In other examples, the multiple values for the same reporting characteristic may be ranked or prioritized according to the value most commonly followed for the diagnostic metric. Multiple treatment times or time ranges may be provided in other examples.

Although the clinician survey of screen 150 may be presented on user interface 104 of programmer 24 or any other computing device, the clinician survey may be presented to the clinician using other methods. For example, the clinician survey may be printed so that the clinician can enter the values of the reporting characteristics. The entries by the clinician may then be manually entered or scanned into a computing device and entered into a database or storage device such as repository 134. A clinic (e.g., a hospital, healthcare group, or other clinic organization) may require all clinicians to complete the clinician survey or screen 150. In other examples, the clinic may provide the appropriate entries for all clinicians or a group or committee of clinicians may enter values for the reporting characteristics for all clinicians of the clinic. In this manner, the selected reporting characteristic made by a clinician or other user of a single clinic may be used to organize the diagnostic metrics for the plurality of clinicians associated with the single clinic.

FIG. 8 illustrates example user interface 104 that includes input fields 188 for customizing content and/or delivery of a patient management report to a clinician. As shown in FIG. 8, screen 180 may include menu 152, headings 182, categories 184, selections 186, input fields 188, clear button 190, and submit button 192. Selection of menu button 152 may navigate to alternative screens such as screen 150 in FIG. 7 or other screens from which the clinician may access other functions of programmer 24. Headings 182 may indicate the categories 184 and the selections 186 that may allow the clinician to customize the receiving patient management reports. User interface 104 of programmer 24 may be used to receive selections from the user in screen 180. However, in other examples, a user interface of another computing device (e.g., computing device 146A) may be used. Server 120 or another computing device that stores the preferences may receive a signal indicative of the user selections.

Categories 184 may include different customizable categories such as “Hide diagnosis after viewing,” “Report diagnosis by:” certain reporting characteristics, “Ranking Scheme,” and “Push Report.” In some examples, screen 180 may include additional categories, each of which may customize the patient management report and/or when the patient management report may be presented to the clinician. In other examples, screen 180 may allow the clinician to create new categories for user specific ways to customize the patient management report. In other examples, categories 184 may include a reminder frequency for each transmitted patient management report. For example, each new patient management report may be pushed each hour. In addition to this new report each hour, reminders may be sent to the clinician to address one or more conditions presented in the report. The reminder frequency may be customizable to a desired duration between reminders such as 1 minute, 5 minutes, 10 minutes, 20 minutes, 1 hour, etc.

In one example, the clinician may decide to hide certain diagnostic metrics from the patient management report. For example, the clinician may not want to be reminded that a diagnostic metric has exceeded its threshold for a certain patient and check the “Yes” selection in input fields 188 for “Hide diagnosis after viewing.” In other examples, the clinician may further refine how and/or when the diagnostic metric may not be presented in a patient management report. For example, user interface 104 may receive a user selection that indicates a duration for which to present diagnostic metrics exceeding a threshold or how many times the diagnostic metric may be presented in a patient management report before being hidden or removed from the report. If a diagnostic metric value drops below a threshold and subsequently exceeds the threshold again, the diagnostic metric may be presented in another patient management report for the new occurrence.

User interface 104 may also receive selection of which reporting characteristic will be used to organize diagnostic metrics of the patient management report. Based on which input field 188 is selected for the “Report diagnoses by:” category, server 120 may generate the patient management report according to the selected reporting characteristic. In the example of FIG. 8, the clinician has selected “Action” such that the diagnostic metrics may be organized by therapy actions. Screen 180 may provide any of the reporting characteristics as one of selections 186. In other examples, user interface 104 may receive selection priorities for each of the reporting characteristics (e.g., a ranking of some or all of the reporting characteristics that be used to further organize diagnostic metrics if two or more diagnostic metrics are tied at the higher priority reporting characteristic).

User interface 104 may also receive a selection of which preferences will be used for the ranking scheme of the patient management report. In the “Ranking Scheme:” category, the clinician may select which preferences to use for the values of the reporting characteristics. The clinician may provide an input to select the personal preferences of the clinician, the average preferences of clinicians at a specific clinic, or even the average preferences of all clinicians in a country or the world to have answered the clinician survey of screen 150. In this manner, the clinician may select how the diagnostic metrics may be organized within each reporting characteristic. In the example of FIG. 8, the clinician has selected to use the preferences of all clinicians at the clinic.

User interface 104 may also receive a selection that indicates when to push the patient management report to the clinician. The clinician may select to have the patient management report pushed (e.g., generated and transmitted) immediately upon a diagnostic metric exceeding a threshold. Alternatively, the clinician may select to have the patient management report pushed hourly or daily. In other examples, the clinician may provide any timing selection to specify when to receive the patient management report. For example, user interface 104 may receive an input indicating that patient management reports should be transmitted any time the clinician logs into his or her clinician account with a service that manages the patient management report.

Once the clinician has entered all desired preferences via input fields 188, the clinician may select submit button 192 to enter the preferences and cause server 120 to receive the selections and store the preferences of the clinician. In other words, preferences entered in screen 180 may be stored by server 120 and used as a trigger for when and how to generate the patient management report. Alternatively, the clinician may select clear button 190 to clear all entries in input fields 188 and start over. In addition to the preferences being stored in a storage device of server 120 and/or repository 134, clinician entered preferences may be stored in programmer 24 and/or IMD 16 of patient 14.

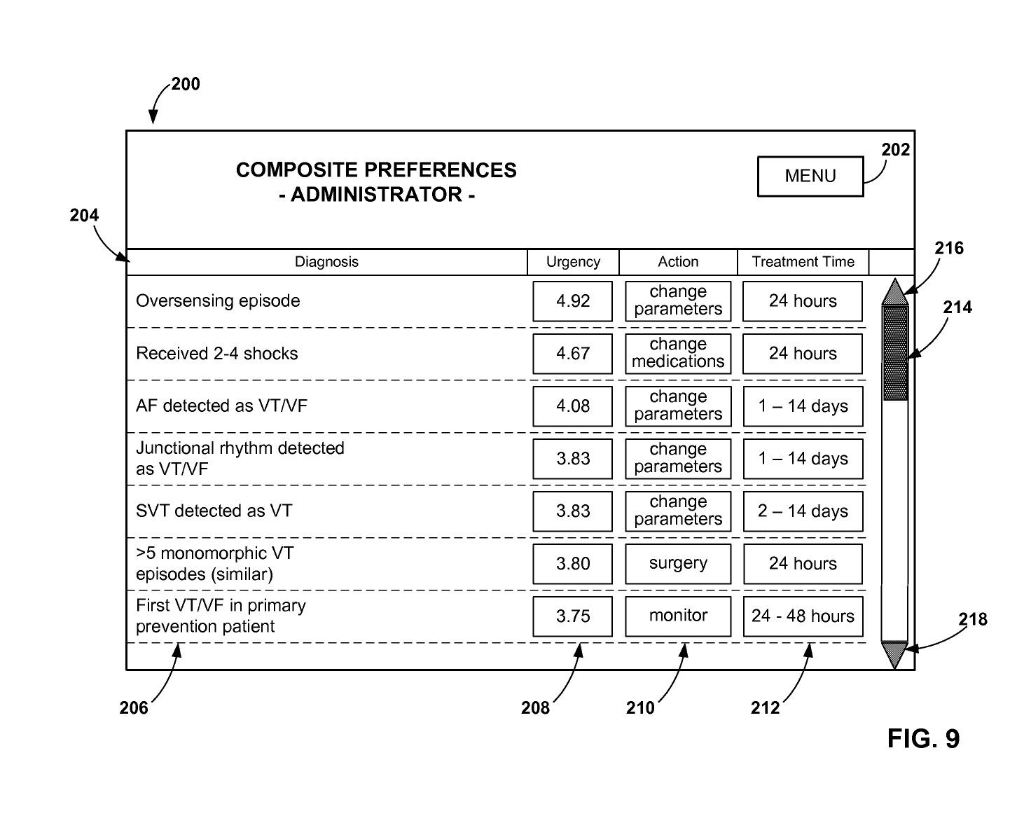

FIG. 9 illustrates an example screen 200 of user interface 128 that includes composite reporting characteristics generated from multiple clinician surveys for a plurality of diagnostic metrics. Screen 200 may be generated from clinician selections received from multiple clinician surveys such as the survey presented in FIG. 7. Although screen 200 is described as being presented on user interface 128 of server 120, screen 200 may alternatively be presented by user interface 104 of programmer 24 of a user interface computing device 146N or by any user interface of any device used by a healthcare professional.

As shown in FIG. 9, screen 200 includes menu 202, headings 204, diagnostic metrics 206, urgency scores 208, treatment actions 210, and treatment times 212. Screen 200 also includes scroll bar 214 and arrow 216 and 218. Screen 200 may be interactive such that the user interface 128 presents screen 200 to receive user input into one or more areas of screen 200. The user of screen 200 may be a clinician, a clinic administrator, or a representative of the service providing screen 200. The user may drag scroll bar 214 or select arrows 216 or 218 to navigate amongst the different diagnostic metrics 206

Diagnostic metrics 206 may be substantially similar to the diagnostic metrics 156 of FIG. 7. However, in some examples, diagnostic metrics 206 may include greater or fewer diagnostic metrics than those in screen 150 of FIG. 7 based on which diagnostic metrics were provided to each clinician. Diagnostic metrics 206 may or may not have thresholds included in the description of each diagnostic metric 206.

For each of the reporting characteristics (e.g., urgency scores 208, therapy actions 210, and treatment times 212), the average or most common value from multiple clinician surveys may be provided in screen 200. In this manner, screen 200 may provide a composite value for each of the reporting characteristics. The composite value may incorporate values from multiple clinicians or fractional values manually selected to differentiate between two or more diagnostic metrics (e.g., to prevent two diagnostic metrics from having the same score). In some examples, the composite values may be generated from weighted clinician surveys such that, for example, more senior clinician selections may be weighted more than junior clinicians. For patient management reports that are generated from multiple clinician values, reporting characteristics such as those presented in FIG. 9 may be used.

For example, screen 200 may list the average urgency scores 208, the most selected therapy actions 210, and the range of treatment times 212 received from clinicians. Each of the reporting characteristics may be a composite value. Table 1 provides a list of example diagnostic metrics 206 and their related thresholds and reporting characteristic values. The threshold value may be used to generate the diagnostic metrics 206 illustrated in FIG. 9. The diagnostic metrics of Table 1 are generally discussed above. The reporting characteristics may include the average value and/or the most common value received from the clinician surveys. For example, the actions may be the most common selection. Less common selections (e.g., alternative therapy actions) may also be presented to a user in other examples.

TABLE 1

| | | | | Treatment |
|---|---|---|---|---|
| Diagnostic Metric | Threshold | Urgency | Action | Time |
| Episode due to oversensing | 1 | 4.92 | Change | 24 hours, |
| | | | parameters | ER |
| Patient received multiple shocks | 2-4 | 4.67 | Change | 24 hours, |
| | | | medication | ER |
| AF inappropriately detected as VT/VF | 1 | 4.08 | Change | 1 day-2 |
| | | | parameters | weeks |
| Junctional rhythm inappropriately | 1 | 3.83 | Change | 1 day-2 |
| detected as VT/VF | | | parameters | weeks |
| Other SVT (e.g., Sinus Tachycardia or | 1 | 3.83 | Change | 2 days-2 |
| AT) inappropriately detected as VT | | | parameters | weeks |
| Monomorphic VT episodes with the | 6 | 3.80 | Surgery | 24 hours |
| same morphology | | | | |
| First-time VT/VF in a primary | 1 | 3.75 | Monitor | 1-2 days |
| prevention patient | | | patient | |
| | | | more, call | |
| | | | patient | |
| VT episode where ATP caused | 1 | 3.67 | Change | 24 hours- |
| acceleration | | | parameters | next visit |
| Frequency of episodes increased | 10% | 3.67 | Change | 2 days-1 |
| | | | medication | month |
| VT episode with multiple ATP attempts | 1 | 3.42 | Change | 24 hours- |
| | | | parameters | next visit |
| Number of VT episodes terminated by 1 | <2 | 2.83 | Change | 2 days-1 |
| ATP | | | medication | week |
| Number of VT episodes terminated by 1 | >5 | 2.60 | Change | 24 hours- |
| ATP | | | medication, | 2 days |
| | | | call patient | |
| Patient received 1 shock | 1 | 2.58 | Call patient | 1-2 days |
| First-time non-sustained VT/VF in a | 1 | 1.92 | None | 2 days-1 |
| primary prevention patient | | | | week |
| Inappropriate mode-switch episode | 1 | 1.67 | Change | 1 week- |
| | | | parameters | next visit |
| First-time mode-switch episode | 1 | 1.67 | Change | 1 week |
| | | | medication, | |
| | | | call patient | |
| High Number of mode-switch episode | >5 | 1.67 | Monitor | 2 days- |
| | | | patient more | next visit |
| First-time shock | 1 | 3.00 | Call patient | 1-2 days |

The diagnostic metrics of Table 1 are not exhaustive. Other potential diagnostic metrics may include lead sensing issues, battery charging issues, device end of life issues, or any other situations in which the clinician may desire to be notified via the patient management report. Each of the diagnostic metrics of Table 1 may be presented to a clinician in the clinician survey of screen 150 in FIG. 7. In some examples, the respective thresholds may also be provided in the clinician survey of screen 150 such that the clinician can enter a desired threshold for each diagnostic metric. Additional diagnostic metrics may also be used in other examples. In addition, some diagnostic metrics provided in Table 1 may alternatively be broken into sub-metrics for display separately. For example, an “Episode due to oversensing” may be split into specific causes for oversensing such as lead fracture noise, T-wave oversensing, P-wave oversensing, R-wave oversensing, and/or electromagnetic interference) Each of these separate diagnostic metrics may include different treatment times, urgencies, and/or actions. For example, lead fracture noise may be the most urgent, but P-wave oversensing may be a less urgent diagnosis to be addressed.

In some examples, the clinic administrator may change or override any of the entries of the reporting characteristics in screen 200. User interface 128 may receive selection of any of the reporting characteristic values and provide an input field in which the user may change the presented value. In this manner, an administrator may review the reporting characteristic values for accuracy and consistency with clinic practice. The clinician may also change one or more thresholds of the diagnostic metrics. In some examples, the user may also use screen 200 to enable or disable certain diagnostic metrics from being used in patient management reports. For example, user interface 128 may receive input from the user selecting one or more diagnostic metrics to be enabled to be included within a patient management report. Alternatively, user interface 128 may receive input from the user selecting one or more diagnostic metrics to be disabled or not included within any patient management reports.

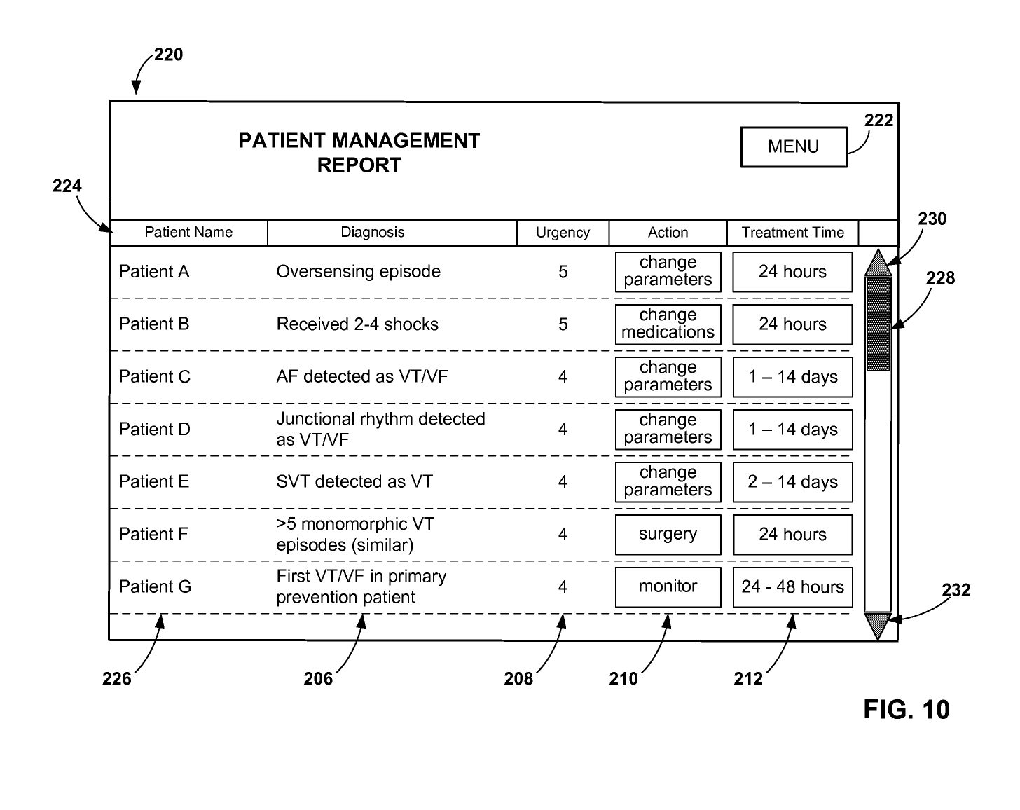

FIG. 10 illustrates an example user interface 104 that presents screen 220 that includes a patient management report. The patient management report of screen 220 may be generated with any diagnostic metrics 206 that exceed their respective threshold. Therefore, screen 220 may include diagnostic metrics 206 organized (e.g., ordered, sorted, or prioritized) according to a specific reporting characteristic (e.g., urgency scores 208). Although screen 220 is described as being presented on user interface 104 of programmer 24, screen 220 may alternatively be presented by a user interface of another device (e.g., computing device 146 or server 120) or by any user interface of any device used by a healthcare professional.

As shown in FIG. 10, screen 220 includes menu 222, headings 224, patients 226, diagnostic metrics 206, urgency scores 208, treatment actions 210, and treatment times 212. Screen 220 also includes scroll bar 228 and arrow 230 and 232. Screen 220 may be interactive such that the user interface 104 presents screen 220 with the ability for the user (e.g., the clinician) to sort diagnostic metrics 206 or perform one or more actions for the patients listed in the patient management report. The user may drag scroll bar 228 or select arrows 230 or 232 to navigate amongst the different diagnostic metrics 206.

Patients 226 may include the names of each patient who is associated with a diagnostic metric 206 exceeding a respective threshold. For example, Patient A may have experienced an oversensing episode with IMD 16. The same patient could be listed multiple times the patients 226 column if the patient has two or more diagnostic metrics that each exceed their respective threshold. Diagnostic metrics 206 may be the same diagnostic metrics 156 presented in the clinician survey of FIG. 7. If a diagnostic metric has not exceeded its threshold for a patient, that diagnostic metric may not be presented in the patient management report. In addition, a diagnostic metric already presented in a previous patient management report may not be presented such that information already known by the clinician is not re-presented.

In addition, the reporting characteristics for each diagnostic metric may be listed. As shown in screen 220, the patient management report may be generated such that diagnostic metrics 206 may be organized by urgency scores 208. In other words, patients 226 may be triaged or ranked based on the most urgent diagnosis first. If the clinician desires to view diagnostic metrics organized according to a different reporting characteristic, user interface 104 may receive the selection of an area of headings 224, such as “Action” of therapy actions 210 or “Treatment Time” of treatment time 212. Upon receiving a new selection of a reporting characteristic for organization of diagnostic metrics 206, server 120 may regenerate the patient management report. In other examples, programmer 24 may reorganize the diagnostic metrics without needing server 120 to regenerate the entire patient management report. In some examples, one or more diagnostic metrics 206 may also be highlighted (e.g., presented with a different color, a different font, or some other distinguishing feature or mark) if the diagnostic metric is new, has changed substantially, or the patient associated with the highlighted diagnostic metric has one or more other diagnostic metrics that may indicate a more serious or urgent condition than one diagnostic metric alone.

In some examples, a single patient may have multiple diagnostic metrics exceeding their respective threshold. For example, Patient A may also qualify for the diagnoses “Received 2-4 shocks” and “>5 monomorphic episodes.” Patients with multiple diagnoses may be ordered with the other patients based on the most urgent diagnoses, for example. In other examples, patients may be ordered based on the most recent diagnostic metric to exceed the respective threshold. In some examples, the action may be synthesized for patients with multiple diagnostic metrics exceeding the thresholds. For example, if an action for one of the diagnostic metrics may treat another metric as well, the patient may be ordered according to the action that may treat multiple diagnostic metrics.

User interface 104 may also facilitate treatment or other actions of the clinician via screen 220. For example, the clinician may take one or more actions through the patient management report. The clinician may select a “change parameters” value of therapy actions 210, and programmer 24 may present a therapy parameter screen to the user via user interface 104. In this manner, the clinician may directly modify the parameters for the patient. This action may be performed when visiting the patient or remotely via network 144. In another example, selection of a “surgery” value of therapy actions 210 may cause programmer 24 to enter a scheduling screen to allow the clinician to request scheduling of a patient appointment to perform the needed surgery. These actions may be performed via pop-up windows or different screens of programmer 24 or another computing device.

In some examples, treatment times 212 may countdown from the time when the diagnostic metric originally occurred to give a more accurate determination of how long until the recommended time for addressing the patient issue is reached. For example, treatment times 212 may include times to give the clinician a real-time understanding or triaging of how long the patient has to be treated. In other examples, the clinician may select one of the treatment times 212 and enter a reminder onto the clinician calendar to address the diagnostic metric. This reminder system may be more effective for less urgent diagnoses.

As described herein, certain diagnostic metrics exceeding their threshold may not be presented in the patient management report when the diagnostic metric has been presented previously. When this occurs, the patient management report may indicate that there is a non-presented diagnostic metric or even how many diagnostic metrics are not presented in the report. The indication may be provided at the top of the report or next to a patient already listed in the report, for example. In this manner, the clinician would be reminded that some patients may need attention even though a diagnostic metric is not listed in the patient management report. In some examples, screen 220 may provide a toggle input that allows user interface 104 to show and hide previously presented diagnostic metrics at the request of the clinician.

In other examples, headings 224 may include additional components. For example, heads 224 may include a “Status” or “Action Taken” column that allows the clinician to track any action taken on a particular patient. The “Status” column may be a field where the clinician can enter notes, place a checkmark, or enter a time and/or date to indicate when the patient was treated. This status column may update the patient management report based on the input. For example, checking a “complete” box in the status column may remove that entry for the patient or move the entry to the bottom of the ordered patient management report. Alternatively, if the patient management report is a printed document, the status column may be a field where the clinician can manually write down notes or otherwise update the status of the patient when visiting patients in the report.

Although the patient management report of screen 220 may be interactive, the patient management report may be static and non-interactive in other examples. For example, the patient management report may be presented by user interface 104 as a static generated group of pages or webpage. In some examples, the patient management report may be presented on a large screen in a clinic to monitor each patient. Alternatively, the patient management report may be printed off and presented as a hard paper copy to the clinician. In other examples, the patient management report may be presented to a clinician's notebook computer, mobile phone, or any other device.

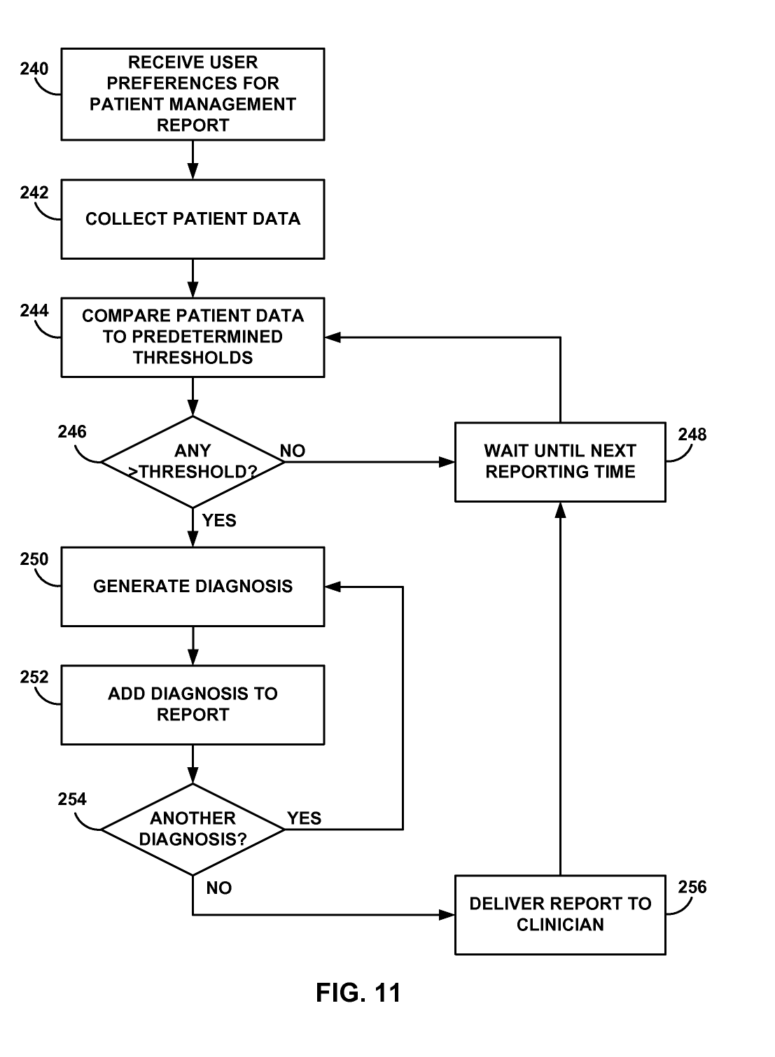

FIG. 11 is a flow diagram of an example technique for generating a patient management report from patient data. The process of FIG. 11 will be described with respect to triage module 130 of server 120 as one example. However, the process of FIG. 11 may alternatively be performed by triage module 106 of programmer 24, computing devices 146, or any other computing device. In addition, one or more aspects of FIG. 11 may be distributed across two or more devices via network 144.

As shown in FIG. 11, triage module 130 may receive user preferences for patient management reports (240). For example, triage module 130 may receive entries from the clinician survey of screen 150 and/or the selections from the reporting preferences of screen 180. In some examples, the clinician survey may include the selections such as which reporting characteristic to use for organizing the diagnostic metrics within the patient management report. Triage module 130 may then collect patient data from one or more sources (242). For example, triage module 130 may collect data from IMDs implanted within patients (e.g., IMD 16) and store the data as IMD data 138 in repository 134. Triage module 130 may also collect patient history information from programmers (e.g., programmer 24), IMDs (e.g., IMD 16), or other databases with patient information via network 144. Triage module 130 may store the patient history data as patient history 136 in repository 134.

Triage module 130 may generate diagnostic metrics from the collected patient data may compare the diagnostic metrics to respective predetermined thresholds (244). Triage module 130 may perform the comparisons as the patient data is collected or only when a patient management report is scheduled to be generated. If no diagnostic metrics are exceeding their respective threshold (“NO” branch of block 246), triage module 130 may wait until the next report period to continue comparing diagnostic metrics to thresholds (248). In other examples, triage module 130 may continue comparing diagnostic metrics to respective thresholds as patient data is collected. In some examples, triage module 130 may monitor those patients of interest to the clinician or patients from which diagnostic metrics may be continued to be compared their respective thresholds. Triage module 130 may flag and monitor any patient with a threshold number of diagnostic metrics exceeding respective thresholds or any other at risk patients for more frequent or continual monitoring. In some examples, triage module 130 may receive a request from a clinician to more frequently monitor one or more patients.

If a diagnostic metric has exceeded its respective threshold (“YES” branch of block 246), triage module 130 may generate the diagnosis (e.g., the indication that the diagnostic metric has exceeded the threshold) (250) and add the diagnosis to the patient management report (252). If there is another diagnosis for a diagnostic metric exceeding its respective threshold (“YES” branch of block 254), triage module 130 may generate another diagnosis for the report (250). If there are no more diagnoses to add to the patient management report (“NO” branch of block 254), triage module 130 may deliver the patient management report to the clinician (256) and wait until the next reporting time to again compare diagnostic metrics to respective thresholds (248).

Triage module 130 may deliver the patient management report to a clinician using different techniques. For example, triage module 130 may command processors 122 to transmit the patient management report to computing device 146A of the clinician via network interface 126 and network 144. In another example, triage module 130 may command processors 122 to store the patient management report in repository 134 for later retrieval by the clinician or a device of the clinician. For example, server 120 may push the patient management report in response to the clinician logging into an account managed by server 120.

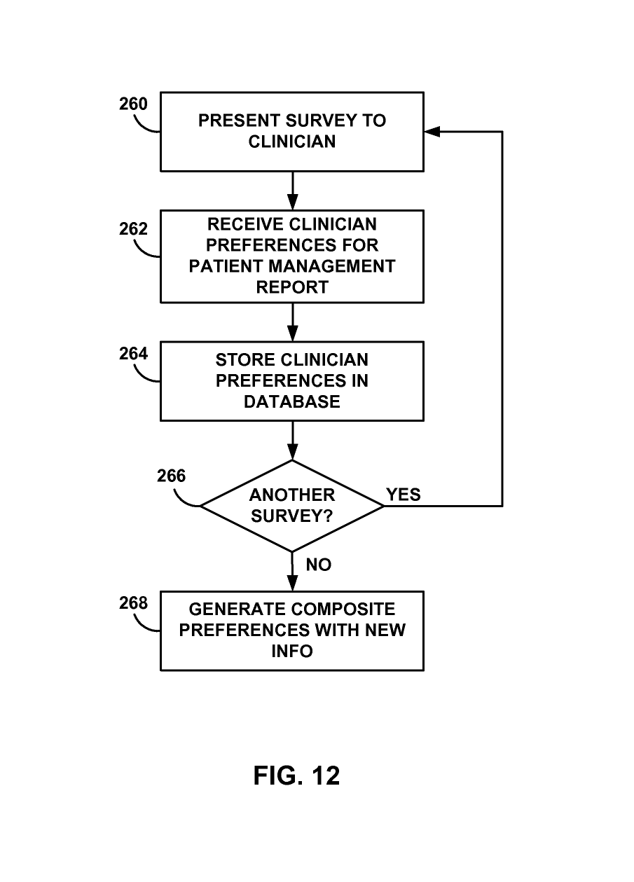

FIG. 12 is a flow diagram of an example technique for receiving clinician input for generating composite reporting characteristics for diagnostic metrics. The process of FIG. 12 will be described with respect to programmer 24 and server 120 as one example. However, the process of FIG. 12 may alternatively be performed by any user interface and one or more devices configured to receive clinician preferences and store the preferences for generating the patient management report.

User interface 104 of programmer 24 may present the clinician survey (e.g., the clinician survey of screen 150 and/or screen 180 of FIGS. 7 and 8) to the clinician (260). The clinician survey may be generated by triage module 130 of server 120 and transmitted to programmer 24 for presentation to the clinician, or triage module 106 of programmer 24 may generate the clinician survey. User interface 104 may then receive clinician input to identify one or more preferences for the patient management report (262). Programmer 24 may transmit the clinician preferences to server 120 for storage in repository 134. In some examples, programmer 24 may also store the clinician preferences in a database within memory 102 of programmer 24.

If triage module 130 is to present another survey to the same clinician or a different clinician (“YES” branch of block 266), triage module 130 may generate the clinician survey for server 120 transmission to the appropriate programmer or computing device for the intended clinician (260). If no further surveys are to be presented (“NO” branch of block 266, server 120 may generate composite preferences with the new information received from one or more clinician surveys (268). The composite preferences may be similar to diagnostic metrics and reporting characteristics shown in screen 200 of FIG. 9. Triage module 130 may store the composite preferences within repository 134 and update the composite preferences when new or updated clinician preferences are received.

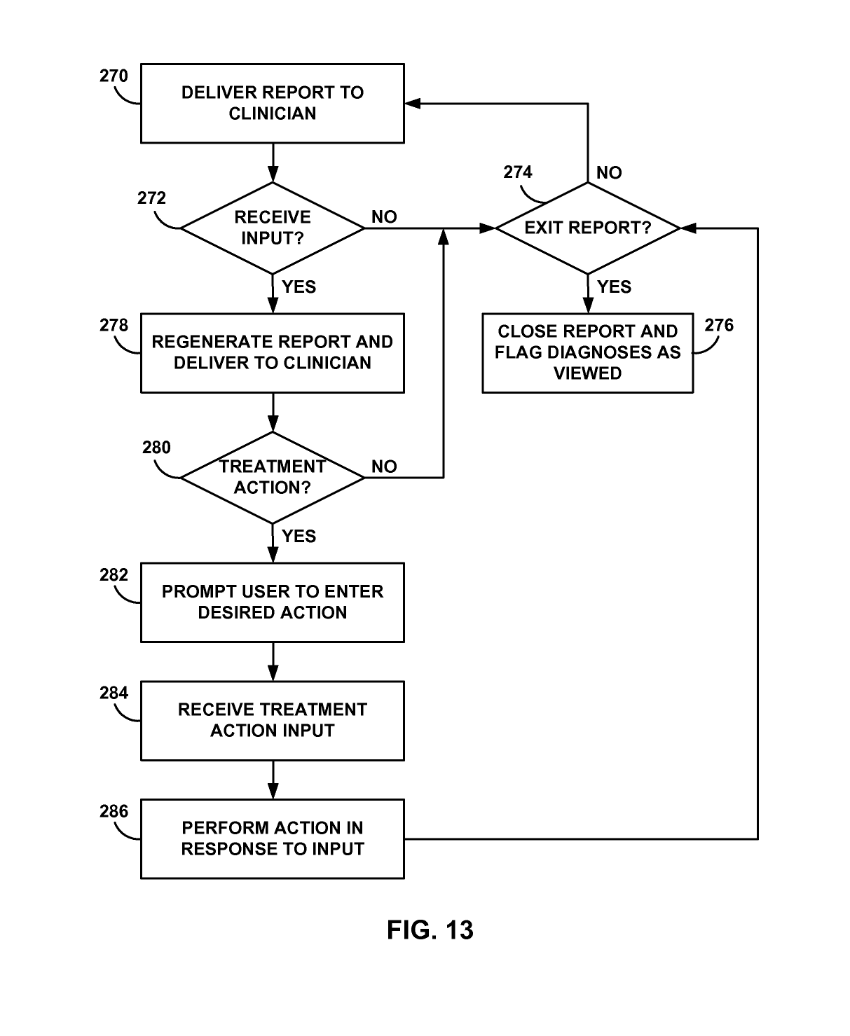

FIG. 13 is a flow diagram of an example technique for presenting an interactive patient management report to a clinician. The process of FIG. 13 will be described with respect to programmer 24 as one example. However, the process of FIG. 13 may alternatively be performed by any user interface and one or more devices (e.g., computing device 146A) configured to receive present an interactive patient management report to a clinician. In other examples, a computing device may present the interactive patient management report to the clinician, but one or more changes to the report may be controlled remotely via triage module 130 of server 120.

As shown in FIG. 13, programmer 24 may deliver the patient management report to the clinician (270). If user interface 104 does not receive any input (“NO” branch of block 272), processor 100 may check if user interface 104 should exit the patient management report (274). If user interface 104 is not to exit the patient management report (“NO” branch of block 274), user interface 104 may continue to deliver the patient management report to the clinician (270). If user interface 104 is to exit the report (“YES” branch of block 274), processor 100 may close the report and flag any viewed diagnoses in the patient management report as viewed by the clinician (276). As described herein, viewed diagnoses may be hidden or removed from patient management reports to minimize information in the reports already known by the clinician.

If user interface 104 receives input to the patient management report (“YES” branch of block 272), triage module 106 may regenerate the patient management report for user interface 104 delivery to the clinician (278). In some examples, programmer 24 may transmit the received input to server 120 and triage module 130 of server 120 may regenerate the patient management report for re-transmittal to programmer 24. Example input that may be received may include selecting a different reporting characteristic (e.g., therapy actions instead of urgency) to organize the diagnoses present in the patient management report.

If a treatment action input is not received by user interface 104 (“NO” branch of block 280), processor 100 may check if the report should be exited (274). If user interface 104 receives a treatment action input from the clinician (“YES” branch of block 280), user interface 104 may prompt the user to enter the desired action (282). For example, the desired treatment action may be to modify therapy parameters for IMD 16 of the patient or change a medication dosage for the patient. Alternatively, the treatment action may be to increase the frequency of patient monitoring or schedule a surgery or other appointment with the clinician. User interface 104 may receive the treatment action input from the clinician that selects which action the clinician may wish to complete (284). In response to receiving this input, programmer 24 and/or server 120 or another computing device may perform the action (286). For example, the requested action may be to change the therapy parameters of IMD 16. User interface 104 may present a screen with adjustable parameters and receive the input from the clinician to change one or more of the parameters. Processor 100 may then check to determine if the patient management report should be exited (274).

In this manner, the interactive patient management report may allow the clinician to perform one or more actions via the patient management report. In other words, the user interface that presents the patient management report may also receive input from the patient that addresses one or more of the diagnoses presented in the patient management report. For example, the user interface may present additional information related to the action such that the clinician can review status of patients from the patient management report and address that patient's status without needing to interact with another device.

The disclosure also contemplates computer-readable storage media comprising instructions to cause a processor to perform any of the functions and techniques described herein. The computer-readable storage media may take the form of any volatile, non-volatile, magnetic, optical, or electrical media, such as a RAM, ROM, NVRAM, EEPROM, flash memory, or any other digital media. The computer-readable storage media may be non-transitory. A programmer, such as patient programmer or clinician programmer, or other computing device may also contain a more portable removable memory type to enable easy data transfer or offline data analysis.

The techniques described in this disclosure, including those attributed to IMD 16, programmer 24, or server 120 and various constituent components, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in programmers, such as physician or patient programmers, stimulators, remote servers, or other devices. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. For example, any of the techniques or processes described herein may be performed within one device or at least partially distributed amongst two or more devices via a network. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Example computer-readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or any other computer readable storage devices or tangible computer readable media.

In some examples, a computer-readable storage medium may comprise non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described that include detecting and collecting patient data, generating diagnostic metrics from one or more sources of data, and generating patient management reports. These examples include techniques for generating and presenting patient management reports may aid clinicians in management of multiple patients present within a clinic and/or patients remote from the clinic. In addition, the patient management report may be customizable to facilitate delivery of the information that the clinician desires to view in each patient management report. Selective presentation of patient status and organization (e.g., triaging or grouping of tasks) may aid in workflow management of clinicians while improving treatment received by each patient. These and other examples are within the scope of the following claims.

1. A method comprising:
receiving a clinician input selecting at least one reporting characteristic for each of a plurality of diagnostic metrics;
organizing, by one or more processors, the diagnostic metrics based on the selected reporting characteristic;
receiving patient data for at least one patient;
determining a value for at least a subset of the diagnostic metrics based on the patient data; and
generating, by the one or more processors, a patient management report comprising the diagnostic metrics having a value that exceeds a respective threshold, wherein the diagnostic metrics are ordered in the patient management report based on the organization.

2. The method of claim 1, further comprising:
presenting a clinician survey to the clinician, wherein the clinician input is received via the clinician survey.

3. The method of claim 1, wherein:
receiving the clinician input comprises receiving, from a plurality of different clinicians, input selecting at least one reporting characteristic for each of the plurality of diagnostic metrics;
the method further comprises generating at least one composite reporting characteristic for each of the plurality of diagnostic metrics based on the selected reporting characteristics from the plurality of clinicians; and
organizing the diagnostic metrics further comprises organizing, by the one or more processors, the diagnostic metrics based on the at least one composite reporting characteristic.

4. The method of claim 1, wherein the reporting characteristic comprises at least one of an urgency score, a treatment action, or a treatment time.

5. The method of claim 1, wherein organizing the diagnostic metrics comprises one of ranking or grouping the diagnostic metrics based on the selected reporting characteristic for each of the diagnostic metrics.

6. The method of claim 1, wherein:
receiving the patient data comprises receiving the patient data for each of the at least one patient from a plurality of sources; and
the plurality of sources comprises at least two of an implantable medical device implanted within the at least one patient, a patient programmer, a clinician programmer, and a remote database.

7. The method of claim 1, wherein, for at least one of the diagnostic metrics, the patient data comprises a sensed component from an implantable medical device and a patient information component entered by a clinician.

8. The method of claim 1, wherein the diagnostic metrics comprise at least two of a number of monomorphic ventricular tachycardia episodes with similar morphology, a first ventricular tachycardia or ventricular fibrillation in a primary prevention patient, a ventricular tachycardia episode caused by anti-tachycardia induced acceleration, an increase in frequency of cardiac episodes, a first non-sustained ventricular tachycardia in the primary prevention patient, and an implantable medical device delivered shock.

9. The method of claim 8, wherein the respective thresholds comprise at least two of six monomorphic ventricular tachycardia episodes with similar morphology, one ventricular tachycardia or ventricular fibrillation in the primary prevention patient, one ventricular tachycardia episode caused by anti-tachycardia induced acceleration, a 10 percent increase in frequency of cardiac episodes, one non-sustained ventricular tachycardia in the primary prevention patient, and one implantable medical device delivered shock.

10. The method of claim 1, wherein the at least one selected reporting characteristic is used to organize the diagnostic metrics for a plurality of clinicians associated with a single clinic.

11. A system comprising:
one or more processors configured to:
receive a clinician input selecting at least one reporting characteristic for each of a plurality of diagnostic metrics;
organize the diagnostic metrics based on the selected reporting characteristic;
receive patient data for at least one patient;
determine a value for at least a subset of the diagnostic metrics based on the patient data; and
generate a patient management report comprising the diagnostic metrics having a value that exceeds a respective threshold, wherein the diagnostic metrics are ordered in the patient management report based on the organization.

12. The system of claim 11, further comprising a network interface configured to transmit the patient management report to a computing device; and wherein
the system comprises the computing device, and
the computing device is configured to receive the patient management report and present the patient management report to a clinician.

13. The system of claim 11, wherein the one or more processors are configured to:
receive, from a plurality of different clinicians, input selecting at least one reporting characteristic for each of the plurality of diagnostic metrics;
generate at least one composite reporting characteristic for each of the plurality of diagnostic metrics based on the selected reporting characteristics from the plurality of clinicians; and
organize the diagnostic metrics based on the at least one composite reporting characteristic.

14. The system of claim 11, wherein the reporting characteristic comprises at least one of an urgency score, a treatment action, or a treatment time.

15. The system of claim 11, wherein the one or more processors are configured to one of rank or group the diagnostic metrics based on the selected reporting characteristic for each of the diagnostic metrics.

16. The system of claim 11, wherein:
the one or more processors are configured to receive the patient data for each of the at least one patient from a plurality of sources; and
the plurality of sources comprise at least two of an implantable medical device implanted within the at least one patient, a patient programmer, a clinician programmer, and a remote database.

17. The system of claim 11, wherein, for at least one of the diagnostic metrics, the patient data comprises a sensed component from an implantable medical device and a patient information component entered by a clinician.

18. The system of claim 11, wherein the diagnostic metrics comprise at least two of a number of monomorphic ventricular tachycardia episodes with similar morphology, a first ventricular tachycardia or ventricular fibrillation in a primary prevention patient, a ventricular tachycardia episode caused by anti-tachycardia induced acceleration, an increase in frequency of cardiac episodes, a first non-sustained ventricular tachycardia in the primary prevention patient, and an implantable medical device delivered shock.

19. The system of claim 18, wherein the respective thresholds comprise at least two of six monomorphic ventricular tachycardia episodes with similar morphology, one ventricular tachycardia or ventricular fibrillation in the primary prevention patient, one ventricular tachycardia episode caused by anti-tachycardia induced acceleration, a 10 percent increase in frequency of cardiac episodes, one non-sustained ventricular tachycardia in the primary prevention patient, and one implantable medical device delivered shock.

20. The system of claim 11, further comprising one or more networked servers that house the one or more processors.

21. A computer-readable storage medium comprising instructions that cause one or more processors to:
receive a clinician input selecting at least one reporting characteristic for each of a plurality of diagnostic metrics;
organize the diagnostic metrics based on the selected reporting characteristic;
receive patient data for at least one patient;
determine a value for at least a subset of the diagnostic metrics based on the patient data; and
generate a patient management report comprising the diagnostic metrics having a value that exceeds a respective threshold, wherein the diagnostic metrics are ordered in the patient management report based on the organization.
